(19) United States
(12) Patent Application Publication
(10) Pub. No.: US 2013/0183420 A1
(43) Pub. Date: Jul. 18, 2013

(54) Premium Quality Refrigerated Vegetable Products and Methods of Making Them

(71) Applicants: Justin Wade Shimek, San Ramon, CA (US); Dalip Kumar Nayyar, Concord, CA (US); Steven Bautista, Walnut Creek, CA (US); David Glen Anderson, Pittsburgh, PA (US)

(72) Inventors: Justin Wade Shimek, San Ramon, CA (US); Dalip Kumar Nayyar, Concord, CA (US); Steven Bautista, Walnut Creek, CA (US); David Glen Anderson, Pittsburgh, PA (US)

(21) Appl. No.: 13/350,094

(22) Filed: Jan. 13, 2012

(51) Int. Cl. A23B 7/10; A23B 7/005; A23B 7/14

(52) U.S. Cl. 426/326; 426/615

(57) ABSTRACT

The disclosure relates to methods of treating whole, cut, or other processed botanical ingredient(s) in a manner that reduces the load of viable food-contaminating organisms (human or other animal pathogens and food spoilage organisms), preferably without substantially altering one or more of the organoleptic properties of the ingredient(s). The method includes subjecting a botanical foodstuff to a high pressure processing (HPP) treatment and to aseptically sealing the foodstuff within a package that contains a microbistat. Such treatments improve the storage stability of the foodstuff and preferably do not significantly alter one or more organoleptic properties of the botanical ingredient(s). Packaged foodstuffs treated as described herein exhibit beneficial properties, such as retention of taste, appearance, and texture and extended shelf life, relative to non-treated foodstuffs.

### FIELD OF THE DISCLOSURE

The disclosure relates generally to the field of processing of fruits or vegetables and fruit- or vegetable-containing foodstuffs, for the purpose of mitigating or eliminating the risk of microbial growth therein or thereon.

### BACKGROUND OF THE DISCLOSURE

High pressure processing (HPP), also known as high hydrostatic pressure processing, pascalization, and bridgmanization, is a technique whereby articles such as food items are subjected to pressure of an intensity and for a duration of time sufficient to reduce the biological activities of cells and their components, thereby decreasing the likelihood that cells subjected to such processing will continue to metabolize or reproduce. As such, HPP treatment can be used to mitigate or eliminate the risk that bacteria, mold, yeast, and parasites will survive or multiply in or on HPP-treated articles. HPP treatment can also be used to reduce the respiration rate of cells in living or previously-living foodstuffs, such as fruits and vegetables.

Foodstuffs intended for human or other animal consumption are susceptible to microbial contamination, especially during handling and processing, and such contamination can endure and increase during storage. A continuing need exists for methods of limiting microbial contamination of foodstuffs such as fruits and vegetables in order to facilitate safe storage thereof. HPP treatments have been widely investigated and reported. Their efficacy for reducing the load of food-contaminating organisms in foodstuffs and thereby extending the period for which foodstuffs can practically be stored has been demonstrated by others, at least for certain types and species of contaminating microorganisms.

In HPP treatments, foods or other articles are often sealed in a container prior to subjecting the sealed container to high pressure, such as 200-1000 MegaPascals (MPa; more typically 200-600 MPa). Because gases are highly compressible at such pressures, some or substantially all gases can be removed from the container prior to sealing it, such as by evacuating gases from the container or by filling the container with liquid prior to sealing it. Liquids and solids, being relative incompressible at these pressures, tend to transmit pressure throughout their volume, provided there are no rigid articles present (e.g., thick, hollow bones or shells capable of preventing transmission of isotropically applied pressure to their interior). Pressure can be applied to the exterior of the article or the exterior of a container containing the article and transmitted throughout the article. In practice, pressurization is often achieved in a sturdy device designed for accommodating one or more articles during such pressurization. Pressurization devices often have controls for selecting the magnitude and duration of pressurization and indicators for indicating the pressure achieved and/or the duration of the pressurization process.

Following HPP treatment, non-compressible articles such as liquid foods (e.g., soups and juices) often appear similar to or indistinguishable from non-treated articles of the same type. Furthermore, many HPP-treated foodstuffs retain their original texture and flavors (or texture and flavors very similar to their original ones) following HPP treatment. Particularly for packaged fruits, vegetables and other foodstuffs having a characteristic solid or semi-solid texture or mouthfeel, retention of the texture or mouthfeel is considered important to many consumers. These characteristics are often degraded, however, by food processing treatments intended to improve food safety and facilitate storage and shipping. By way of example, retorting (heat treatment of foodstuffs in sealed containers, typically at superatmospheric pressure) is a common and relatively inexpensive method of enhancing storage stability (e.g., by reducing the load of contaminating organisms) in foodstuffs, but has the drawback that differences in the organoleptic properties of foods are substantial for some foodstuffs. Maintenance of organoleptic properties of ripe, recently-harvested fruits and vegetables, for example, is considered desirable. However, retort processing of fruits and vegetables can significantly alter their organoleptic properties (flavor, color, texture, crispness) in ways that render the retorted foodstuffs less desirable to consumers.

HPP treatments have been investigated as a substitute for retort and other processing methods for improving storage stability of botanical foodstuffs. For many microorganisms, HPP treatment alone reduces the number of viable, vegetative organisms and improves storage stability and microbiological safety. However, a significant drawback of HPP treatment for botanical foodstuffs is that the high pressure treatment alone often does not inactivate all food-contaminating organisms that can cause disease or spoilage. By way of example, some microorganisms (including some human pathogens) are known to exhibit significant resistance to HPP treatment alone (e.g., spores of certain molds, fungi, and bacteria such as Clostridium species including C. botulinum and C. perfringens, and Bacillus species including B. cereus, and cysts of organisms such as those of the genera Cryptosporidium, Cyclospora, and Toxoplasma). Spores of C. botulinum are a well-recognized danger in the field of food processing, in that they are known to survive and proliferate under anaerobic or microaerophilic storage conditions, even in HPP-treated foods. Unfortunately, many of those spores and cysts occur naturally on or in close association with foodstuffs or their ingredients (e.g., in soil), including in vegetables. The presence of those organisms in such foodstuffs necessitates processing to reduce the likelihood that they will cause mortality or morbidity in consumers. Examples of human food pathogens of concern include Clostridium sporogenes, Escherichia coli, Listeria inocua, Salmonella species and Staphylococcus aureus. Also of concern, albeit for their ability to induce spoilage in human foodstuffs are organisms such as Bacillus coagulans, a variety of Lactobacillus species, Saccharomyces cerevisiae and other yeasts, and Penicillium and other molds. The need for appropriate processing of human and animal foodstuffs in order to reduce or prevent disease and spoilage is well known.

A substantial need exists for methods of processing foods that potentially contain HPP-resistant microorganisms and that are intended for human consumption (or for consumption by other animals, such as pets, companion animals, and farm animals). Such methods should preferably by applicable to a broad range of foodstuffs, especially botanical foodstuffs (i.e., those which are, or are derived from, plants and parts thereof or include such plants or parts) and should preferably enable storage for extended periods of time (e.g., days, weeks, or months) without significantly altering, at least in undesirable ways, the pre-processing appearance and/or organoleptic properties of the treated foodstuff.

Disclosed herein are methods of treating botanical foodstuffs to reduce both their load of disease- and/or spoilage-causing organisms and, preferably, also to retain much of the appearance and organoleptic properties of the foodstuffs prior to such treatment. The methods disclosed herein facilitate long-term storage of treated foodstuffs.

### DETAILED DESCRIPTION

The disclosure relates to methods of food processing that enhance the microbiological safety of processed plants, plant parts, and foodstuffs that include them, that decrease the spoilage effects induced by the presence of food-contaminating organisms, or that achieve both of these ends.

HPP food-processing methods are well known and described by others, and are known to be effective for enhancing the microbial safety of treated food products. It is believed that the high pressures (e.g., about 20-120 kpsi) exerted upon HPP-treated foods renders many viable and vegetative pathogenic microorganisms harmless. Similarly, HPP treatment can inactivate some microorganisms that are responsible for spoilage of packaged foodstuffs. Survival of viable food-spoilage organisms in a packaged foodstuff can lead to undesirable tastes, colors, or appearances, decreasing the comestibility of the foodstuff more rapidly than the same foodstuff that does not contain viable food-spoilage organisms.

HPP methods have the significant drawback that HPP treatment often fails to render harmless some (e.g., pressure-insensitive) food-contaminating organisms (FCOs) such as pathogens and food spoilage organisms, that either occur naturally in some foodstuffs or are introduced during harvesting or processing.

Pressure-insensitive FCOs can occur in soil, plants, animals, and food processing equipment and workers, and they can be transmitted from these or other sources into or onto foodstuffs. Failure to eliminate or inactivate FCOs can lead to serious human or veterinary illnesses upon ingestion of the pathogens, to relatively early spoilage of foodstuffs (even those that are refrigerated), or to both. For that reason, treatment, using HPP processes alone, of foodstuffs which can reasonably be anticipated to potentially harbor pressure-insensitive FCOs may not reduce FCOs to microbiologically-safe, comestible levels. Pressure-insensitive FCOs can be eliminated or inactivated by treating such foodstuffs by one or more supplemental antimicrobial treatments, such as heat treatment, combination of the vegetable or foodstuff with an antimicrobial agent, or some combination of these. For many botanical foodstuffs, such methods were previously the only known way of reducing FCO levels sufficiently to facilitate long-term storage of the foodstuff. Alternatively, pressure-insensitive FCOs can be inactivated by packaging the foodstuff with one or more microbistats, before or after HPP treatment. Particularly in situations in which HPP treatment reduces FCO load, relatively small amounts of microbistat(s) can be effective to inactivate the remaining HPP-resistant FCOs.

Certain heat treatments of botanical foodstuffs can result in undesirable organoleptic changes to the foodstuff. Because avoidance of such changes is a common motivation for using HPP techniques in the first place, it can be desirable that any supplemental antimicrobial heat treatment be a relatively gentle heat treatment (e.g., blanching) that will induce relatively few and subtle organoleptic changes. Likewise, contact or combination with certain antimicrobial agents can alter the taste, texture, or color of vegetables and foodstuffs, especially at the most efficacious concentrations of such agents. When HPP treatments as described herein are used in combination with such agents, it can be preferable to use the agent(s) at concentrations at which undesirable organoleptic changes to the treated vegetable or foodstuff are controlled and, more preferably, substantially undetectable by most consumers. As described herein, the antimicrobial effects of HPP treatment, various heat treatments, and combination with various antimicrobial agents can be cumulative, complementary (in that some are more effective against certain types of microbes than others), or both. As a result no single HPP, heat, or antimicrobial treatment need be employed under conditions of maximal effectiveness, but can instead be employed under conditions that induce relatively few or relatively undetectable organoleptic changes in treated foodstuffs.

Food processing methods capable of reducing or eliminating the health and spoilage threats attributable to FCOs that occur naturally in vegetables and other foodstuffs or that are introduced into foodstuffs during their processing could avoid the effort, expense, and organoleptic changes associated with methods previously used by others to address such FCOs. This disclosure provides such food processing methods.

Simply summarized, the methods involve processing botanical foodstuffs using at least two complementary methods. One of the two methods is an HPP treatment, which will inactivate or kill pressure-sensitive viable FCOs (VFCOs), and the other method is aseptically packaging the foodstuff with a microbistat, which will inactivate any remaining, non-pressure-sensitive VFCOs sufficiently that the foodstuff does not, even when stored for a month (30 days) or more, exhibit undesirable health or storage characteristics. In addition, further antimicrobial treatments, such as a heat treatment method or a method of contacting the foodstuff with an antimicrobial agent, can be performed upon the foodstuff to further reduce the FCO load. The various methods can be performed sequentially in any order, can be performed in a temporally-overlapping manner, or they can be performed simultaneously (e.g., by employing an HPP treatment process that uses a microbistat-containing liquid as the working fluid within the pressure vessel of the HPP process, by heating the HPP process fluid or permitting it to heat during HPP treatment, or by some combination of these).

In a preferred embodiment, the botanical foodstuff is subjected to several VFCO-inactivating treatments, including at least an HPP treatment, contact with a microbistat, and at least one of a heat treatment and contact with an antimicrobial agent. By way of example, a botanical foodstuff such as a vegetable can be contacted with an antimicrobial sanitizing agent (e.g., peracetic acid, chlorinated water, or ozonated water) before, during, and/or shortly after it is cut, peeled, or otherwise processed. If consistent with preparation or consumption of the foodstuff, the foodstuff can be heat treated, such as by blanching or cooking The foodstuff can be contacted with a fluid that includes a microbistat, such as a bacteriocin (a bacteriostat) or an antimycotic agent (a fungistat). The microbistat can be an acidulant (e.g., a food-grade acid such as acetic, citric, or lactic acid) to reduce the pH of the combination to a value (e.g., not greater than about 4.6) sufficient to inhibit germination of non-vegetative organisms (e.g. Clostridium or Bacillus spores), to inhibit growth or proliferation of vegetative organisms, or some combination of these.

The foodstuff and a microbistat-containing fluid can be contacted in an evacuated (i.e., pressure<0.1 atmosphere) vessel, such that the liquid is taken up into voids within the foodstuff and yield a foodstuff having the agent throughout (such as a packaged foodstuff comprising an acidulant disposed within foodstuff voids and interstices such that pH is equilibrated throughout the interior of the package). The foodstuff can be aseptically sealed (e.g., vacuum sealed or hermetically sealed sufficiently to substantially prevent microbial passage through the seal) in an HPP-compatible package (e.g., a flexible plastic pouch such as a polyethylene pouch, or one made of laminated plastic sheets having a substantially oxygen-impermeable layer, such as an ethyl vinyl alcohol (EVOH) copolymer layer).

The package can be subjected to an HPP process, such as one that exerts pressure upon and throughout the pouch of 20-120 kpsi (preferably 35-87 kpsi, such as for 1-30 minutes, in either a single pressurization step or a series of alternating or pulsatile pressurization/depressurization cycles). The HPP technique can be expected to render innocuous any pressure-sensitive VFCOs that may be present within the pouch.

During HPP treatment, the temperature of the package can be controlled. For example, the temperature of the HPP working fluid can be maintained at approximately ambient temperature (e.g., ca. 4 or 20 degrees Celsius). Further by way of example, the temperature of the HPP working fluid can be permitted to rise (or heated) to a desired level, such as a temperature known to inactivate one or more FCOs known or suspected to be present in the foodstuff. Methods of regulating the temperature of fluids such as HPP working fluids are well known, and the particular method used is not critical.

Following all of these treatments, the sealed package can be stored under refrigeration (e.g., at 4 degrees Celsius or less). So long as the package is capable of substantially preventing passage of VFCOs across the package material, the stored, packaged foodstuff can be stored for an extended period, such as one, four, six, eight, ten, twelve, or eighteen months, or even longer, and the contents will remain comestible.

Advantageously, the methods described herein can be used to prepare packaged foodstuffs that can be safely eaten by humans or animals with reduced or no danger of food poisoning (or other adverse health effects) attributable to pathogens borne by the packaged foodstuffs and with greatly reduced or eliminated spoilage characteristics. Furthermore, the methods described herein can be used to make packaged foodstuffs that can be stored for long periods, preferably with refrigeration or freezing of the packaged foodstuff. Thus, botanical foodstuffs treated as described herein can be stored under refrigerated conditions (e.g., at a temperature of about 4 degrees Celsius) for days, weeks, months, or years without significant concern for pathogenic contamination, and in some instances without the need for refrigeration.

Definitions

As used herein, each of the following terms has the meaning associated with it in this section.

A “foodstuff” is an item or article that is edible (including drinkable) by a human or a non-human animal or is useful as an ingredient for making an edible item or article. Non-limiting examples of foodstuffs include vegetables, juices, flours, pastas, animal milks, yogurts, cheeses, sweetened beverages, cuts of meat, and processed foods such as cooked or non-cooked entrees or meals.

A “botanical” foodstuff is one that is or contains a fruit, vegetable, tuber, grain, or other plant material. Botanical foodstuffs include fruits, seeds, leaves, stalks, berries, nuts, grains, flowers, shoots, roots, and tubers, for example. Examples of common botanical foodstuffs eaten by humans include peas, beans, carrots, corns, squashes, lettuces, tomatoes, onions, peppers, okra, potatoes, apples, oranges, mangoes, pineapples, peanuts, oats, and cherries. The term also includes within its scope sliced, crushed, ground, peeled, shelled, pared, or other physically altered forms of plant materials and portions thereof (e.g., wheat flours, corn meals, sliced onions, shelled peas, shredded carrots, mashed potatoes, peanut butters, ground peppercorns, crushed garlic cloves, cut salad greens, minced parsley, and fruit and/or vegetable juices). Despite the fact that edible fungi are not, taxonomically, plants, edible mushrooms and other edible fungi are included within the scope of “botanical” foodstuffs for the purpose of this application.

A “food-contaminating organism” (“FCO”) is a pathogenic microorganism or a spoilage microorganism. FCOs can be both pathogenic microorganism and spoilage microorganisms. Some FCOs can exist in multiple forms, including in a vegetative form and a pressure-insensitive form.

A “vegetative” FCO is one which is actively proliferating (e.g., by division or budding). The “vegetative fraction” of a population of FCOs is the number of vegetative FCOs in the population divided by the total number (i.e., vegetative+non-vegetative) FCOs in the population.

A “pressure-sensitive” form of a pathogenic microorganism is a form which is incapable of maintaining or re-attaining a vegetative form after it has been subjected to hydrostatic pressure characteristic of HPP methods (e.g., 20-120 kpsi), while “pressure-insensitive” form of a pathogenic microorganism is a form that is capable of maintaining or re-attaining a vegetative form after being subjected to such pressure. Non-vegetative spores and cysts of pathogenic microorganisms are common forms of pressure-insensitive pathogens, but it is recognized that such pressure-insensitive forms remain relatively poorly characterized and the terms “spore” and “cyst” are loosely used by workers in this field. Furthermore, some vegetative microorganisms are pressure-insensitive.

A “viable” FCO (VFCO) is one which is actively metabolizing (e.g., producing pathogenic toxins or compounds which result in foodstuff spoilage, such as disagreeable tastes or gas), growing in size, or reproducing (e.g., by division or budding). The “viable fraction” of a population of FCOs is the number of VFCOs in the population divided by the total number (i.e., viable+non-viable) FCOs in the population.

An FCO is “inactivated” when it is converted (e.g., by contact with a microbistat or by undergoing an HPP treatment) from a viable form to a non-viable form of the FCO.

A “pathogenic” microorganism (or “pathogen”) is one which is capable of causing a human or veterinary disease (e.g., food poisoning) when ingested by a human or animal.

A “spoilage” microorganism is one which is capable of causing spoilage of a human or animal food product when present in a viable form in a food product stored at 4 degrees Celsius.

An article or ingredient is “comestible” if it is suitable for eating as a food or as a component of a food. Comestible articles will generally not have a taste, texture, aroma, or mouthfeel that would render an otherwise edible, appetizing food unappetizing or inedible when combined with the food.

“Organoleptic” properties of vegetables and foodstuffs refer to the properties that can be detected using the sense organs of an animal, such as color, taste, scent, texture, consistency, and combinations of these, such as the combination of sensations referred to in this field as “mouthfeel.”

An “HPP-compatible” package is a package which is capable of isolating a packaged item (e.g., a foodstuff, with or without additional fluid such as a sauce or brine) from the environment surrounding the package and which is capable of maintaining that isolation upon subjecting the package to an HPP technique, such as pressurization to 20-120 kpsi and allows the pressure to be transmitted to the interior of the package.

The “storage stability” of a vegetable or a vegetable-containing foodstuff refers to the characteristic of the vegetable or foodstuff remaining in a microbiologically safe, comestible state when stored in a hermetically sealed package at 4 degrees Celsius.

An “antimicrobial agent” is a compound or composition of matter that inhibits or prevents one or more of i) growth of an FCO; ii) replication of an FCO; iii) metabolism in an FCO; iv) germination of a pressure-insensitive form of an FCO such as a spore or cyst; v) conversion of a pressure-insensitive form of an FCO to a vegetative, pressure-sensitive form of the FCO; and vi) survival of an FCO, including a pressure-insensitive form or a vegetative form thereof. A wide variety of antimicrobial agents are known in the art, including those effective against pressure-insensitive forms. It is also understood by skilled artisans in the field that the amount or concentration of an antimicrobial agent necessary to exert such activity varies in predictable ways with the identity of the agent, the identity of the FCO, the characteristics of the ambient environment of the FCO, and other factors within the ken of the skilled artisan.

A “microbistat” is an antimicrobial agent that inhibits or prevents one or more of i)-v) above (i.e., a microbistat does not necessarily affect survival of an FCO). A wide variety of microbistats are known, such as bacteriocins, antimycotics, and acidity levels (e.g., pH not greater than 4.6 will inhibit germination of Clostridium and Bacillus spores). When organic or inorganic acids are used as a microbistat, they are preferably selected from among known (and preferably regulatory-agency-approved) food additives, such as hydrochloric and phosphoric (inorganic) acids, or acetic, citric, or lactic (organic) acids. Furthermore, agents which block or disguise the acidic taste of added acids (commonly known as “acid blockers”) are well known and can be used in connection with acidulants used as microbistats in the processes described herein.

A “pathologically significant amount” of VFCOs is an amount of one or more pathogenic VFCOs that is sufficient to substantially increase the likelihood that an animal consuming such an amount of the VFCOs will develop a pathological condition (e.g., will develop food poisoning).

An “aseptic” seal of a package is a junction formed between two portions of the package that substantially prevents passage across the junction of FCOs during long-term storage of a botanical foodstuff or a food containing a botanical foodstuff under ordinary storage conditions (e.g., refrigerated or frozen storage at 4 degrees Celsius or lower).

“Long-term” or “extended” storage as used herein means storage for a period of at least one month, and preferably for at least six months.

The unit “kpsi” is used in its art-accepted sense, i.e., thousands of pounds per square inch of (gauge) pressure.

### DETAILED DESCRIPTION

This disclosure relates to methods of packaging a botanical foodstuff in a manner that reduces the load of viable food-contaminating organisms (VFCOs) in the foodstuff Foodstuffs packaged in this manner are particularly suited for long-term storage, in that the likelihood that the foodstuff will harbor a pathologically significant amount of one or more VFCOs will be decreased, relative to an un-treated foodstuff, and in that the incidence and rate of spoilage will be significantly decreased, owing to inactivation of VFCOs that may be present in the foodstuff. As a result, foodstuffs treated as described herein will exhibit significantly reduced risk that a consumer will develop food poisoning or other pathological conditions attributable to a pathogenic microorganism borne by the vegetable or foodstuff The microbiological safety of the foodstuff is thereby enhanced. Furthermore, foodstuffs treated as described herein will exhibit enhanced storage stability, for example resisting spoilage for at least about one month when stored under refrigerated conditions.

The methods involve subjecting the botanical foodstuff to a high pressure processing (HPP) treatment and packaging the foodstuff with a microbistat (i.e., such that the microbistat can contact the foodstuff within the package). The HPP treatment inactivates at least some VFCOs in the foodstuff, and the microbistat inactivates substantially all VFCOs that are present in the foodstuff and that are not inactivated by the HPP treatment. Thus, substantially all VFCOs are inactivated in the packaged foodstuff, which renders it suitable for long-term (e.g., 1, 4, 6, 8, 10, 12, or 18+ month) storage in a comestible state, especially if the packaged, treated foodstuff is stored under refrigerated (≦4 degrees Celsius) or frozen (≦0 degrees Celsius) conditions. The combination of the HPP treatment and packaging with a microbistat is sufficient to significantly reduce the viable fraction of FCOs that are present in the foodstuff prior to HPP treatment and packaging with the microbistat, such as a five-, six-, seven-, or eight-log (i.e., 100,000-, 1,000,000-, 10,000,000-, or 100,000,000-fold, respectively) reduction in the number of VFCOs present in or on the foodstuff (i.e., reducing the viable fraction of VFCOs by at least 99.999%, by at least 99.9999%, by at least 99.99999%, or at least 99.999999%, respectively).

The foodstuff can, optionally, also be subjected to at least a first supplemental antimicrobial treatment. Subjecting the foodstuff to one or more supplemental antimicrobial treatments can further reduce VFCOs in the foodstuff, further improving the safety, storage, and comestibility characteristics of the packaged foodstuff. For example, the supplemental antimicrobial treatment can be a heat treatments or combination of the foodstuff (or a fluid that contacts the foodstuff) with an antimicrobial agent.

The supplemental antimicrobial treatment can be a heat treatment, such as blanching or retorting. Alternatively the supplemental antimicrobial treatment can consist of or include combination of the foodstuff or a botanical ingredient of the foodstuff with an antimicrobial agent, such as a non-specific antimicrobial sanitizer (e.g., peracetic acid, chlorine, and ozone) or a selective antimicrobial agent, such as a bacteriocin or an antimycotic agent. The foodstuff or ingredient can be combined with a fluid (either a gas or a liquid) that comprises the agent and thereafter subjected to depressurization and repressurization in order to infuse the fluid (and agent) into the foodstuff or ingredient.

The process can include multiple supplemental antimicrobial treatments. The antimicrobial treatments should be selected to reduce VFCOs in the foodstuff, especially those which are not inactivated by the HPP treatment, those which may be resistant to the microbistat, or both. By way of example, it can be advantageous to include in the process both a heat treatment and combination with a non-specific antimicrobial sanitizer, in addition to the HPP treatment and contact with a microbistat. The order in which the various treatments are performed is generally not critical. The various treatments can be performed serially, simultaneously, or in a manner overlapping in time. By way of example, a botanical foodstuff can be contacted with a liquid containing a non-specific antimicrobial sanitizer such as dissolved chlorine gas, rinsed with clean water, aseptically sealed in an HPP-compatible package in a fluid containing a heat-stable bacteriocin (a microbistat), and thereafter subjected to HPP treatment in which the temperature of the foodstuff is permitted to rise, at least briefly, to a temperature that inactivates at least VFCOs, and then rapidly cooled and thereafter maintained in refrigerated storage. By way of an alternative example, cut and rinsed vegetable pieces can be soaked (or vacuum-infused) with a peracetic acid solution, strained from the bulk solution, steam blanched, rapidly cooled, packaged in a low (<4.6) pH comestible sauce containing a microbistat (e.g., acetic acid derived from the infused peracetic acid solution) in an HPP-compatible package, and subjected to HPP treatment, followed by refrigerated storage.

Substantially any combination of antimicrobial processing treatments that will not degrade, to an undesirable degree, the organoleptic properties of the botanical foodstuff can be used. Desirable organoleptic properties of botanical foodstuffs that can be conserved using the processes described herein include, for example, textures (e.g., crispness), flavors, and colors. For many botanical foodstuffs, the flavors and colors characteristic of a fruit or vegetable prior to cooking are preferably retained (preferable, that is, to corresponding flavors and colors that are characteristic of the fruit or vegetable after cooking) Thus, for example, the processes described herein can be used to improve the storage stability and microbiological safety of botanical foodstuffs while retaining the fresh, characteristic flavor of fruits and vegetables that are harvested at or near the peak of their ripeness.

An important characteristic of the processes described herein is that botanical foodstuffs that are treated using the processes can be safely stored for longer periods that the same foodstuffs that are not so treated, or that are treated using many other known anti-microbial methods. Coupled with the limited degree to which the organoleptic properties of treated foodstuffs are altered, the improved storage characteristics of foodstuffs treated as described herein are a significant advantage of those treatment methods. By way of example, the processes described herein can reduce the viable fraction of some or all pathogenic microorganisms and spoilage microorganisms present in a foodstuff (relative to pre-treatment levels) sufficiently that the foodstuff remains comestible after storage of the vegetable at 4 degrees Celsius for one week, one, four, six, eight, ten, twelve or even eighteen months or longer.

Packaging with a Microbistat

The foodstuff can be packaged (or the package sealed) after the HPP technique is performed upon the foodstuff, but is preferably packaged and sealed before the HPP technique is performed, because this eliminates the risk that the HPP-treated foodstuff could become contaminated with VFCOs after HPP treatment but before or during packaging or sealing.

In a preferred embodiment, a foodstuff is contacted with the microbistat-containing fluid prior to or during packaging, and the foodstuff is packaged into an HPP-resistant package. A wide variety of HPP-resistant packages are known, such as flexible plastic pouches and relatively rigid plastic trays having a concave portion and having a flexible plastic lidding material (e.g., a thin transparent sheet) adhered to or fused with the perimeter of the tray about the concavity and conforming to the shape of a foodstuff or collection of foodstuffs contained within the concavity of the tray. The package can contain the foodstuff having the microbistat-containing fluid infused therein (i.e., with no fluid remaining outside the foodstuff), the foodstuff and the microbistat-containing fluid, the foodstuff and a liquid other than the microbistat-containing fluid (e.g., a comestible sauce or liquid intended to aid in cooking the foodstuff), or some combination of these.

Substantially any HPP-compatible packaging materials can be used, such as plastic films and metalized (e.g., foil-coated plastic) films. Such films include polyethylenes and other polyalkenes, nylons, polyethylene terephthalates, and laminated polymer films known in the food industry. Packaging films having selective permeability characteristics can be used, and a wide variety of such films are known, including those (e.g., ethyl vinyl alcohol copolymers) that exhibit selective permeability to certain gases such as oxygen and water vapor. The package must have sufficient flexibility and resilience at at least one portion thereof that the pressure exerted upon the exterior of the package during HPP treatment can be transmitted into the interior of the package without rupturing the package. Thus, most packages will not contain substantial amounts of gaseous components (which are high compressible and result in high stresses upon the packaging during HPP treatment, leading to an increased likelihood of rupture). However, so long as the materials and structure of the package can maintain their integrity (e.g., not rupture or lose their gas-barrier properties) when subjected to HPP treatment, it is not critical how much headspace is contained within the package. In a commercial package filling line, it can be difficult to fill all or most packages completely, and packages will typically exhibit at least some minimal headspace, even on a vacuum packaging line. Based on experience, headspace (i.e., gas-filled space) of up to at least 5%-8% by volume can occur in typical flexible plastic food packaging without rendering them unsuitable for HPP treatment, by way of example.

Cooking by microwave irradiation of foodstuffs is well known and is a convenient method for rapidly heating foods—especially those containing water or other materials that absorb microwaves produced by consumer or commercial microwave ovens. Particularly convenient to consumers are packaged foodstuffs (e.g., sauced vegetables or blends of vegetables with rice or other grains) that can be cooked within their package. Many microwavable packaged foodstuffs are available, for example, in which a foodstuff is contained within a tray having a film sealing a concavity within the tray, there being a substantial headspace between the film and some or all of the foodstuff. Typically, the film must be breached prior to cooking to prevent unexpected or undesirable rupture (e.g., explosion) of the package, and significant gas-filled headspace is typically included between the foodstuff and the film to facilitate such pre-heating breach. This headspace generally renders them unsuitable for HPP treatment. However, packages having less or no headspace can be difficult to controllably breach prior to microwaving.

A variety of microwavable food packages having mechanical venting systems are known, such as those described in U.S. patent application publications numbers 2011/0179754 and 2005/0276885, and vented packaging is commercially available, such as from Amcor Limited and its subsidiaries Amcor Flexibles Europe & Americas and Amcor Flexibles Asia Pacific. Their use to contain foodstuffs during HPP treatment and thereafter for microwave cooking does not appear to have been previously reported.

The methods disclosed herein can be used to prepare a microwaveable packaged food product. In such methods, it is important to select packaging material such that the filled, sealed package is capable of withstanding HPP treatment while retaining the venting mechanism in an operable state. Two examples of suitable venting systems are the Amcor VENTVALVE brand system and the Amcor PROTECTVALVE brand system, each available from Amcor Limited or one or more of its subsidiaries. Such technologies employ packaging films having weakened sections at identified positions, such that significantly greater pressure within the sealed package (e.g., upon production of steam on microwaving) induces the weakened section(s) to rupture, releasing the pressure in a controlled fashion and at a defined location. Such packages are generally suitable for HPP treatment, which applies pressure equally about and within the package, and especially if the package contains no substantial amount of a compressible fluid such as air or other gases.

Alternatively, if it is not possible to retain the venting function when the sealed package is subjected to HPP treatment, the packaging material and foodstuff can be subjected to the HPP treatment prior to sealing the package, so that the venting functionality of the packaging is retained. Because it can be inconvenient or difficult to complete packaging in a sterile fashion after HPP treatment, the methods preferably involve use of sealed, vented packaging material.

In one embodiment, a foodstuff such as a vegetable, grain, and sauce medley (including a microbistat-containing fluid as described herein) is packaged in a material consisting of a lidding film and a tray that is substantially more rigid than the lidding film. The tray includes a concave portion that contains the foodstuff. The lidding film is sealed about the perimeter of the concave portion (e.g., at the edge of the concavity or beyond that edge, such as at a flat portion that extends away from the edge of the concavity). Within the perimeter seal, the lidding film conforms to (i.e., is closely spaced against) the foodstuff, where present, and the surface of the tray where the foodstuff is not present. A rupturable valve, such as an ultrasonic seal between the lidding film and the tray as described in U.S. patent application publication number 2011/0179754, is also present in the lidding film within the perimeter. Preferably, there is substantially no compressible fluid present between the lidding film and the tray within the perimeter seal. The package can be subjected to an HPP treatment (e.g., maintaining the package within a fluid medium pressurized to 20-87 kpsi for 1 to 10 minutes) without affecting the rupturability of the seal. Such HPP treatment inhibits VFCOs within the package, and the microbistat-containing fluid within the package inhibits pressure-insensitive VFCOs that may be present therein. The HPP-treated package exhibits favorable storage characteristics (i.e., including substantially enhanced microbiological safety, relative to the non-treated foodstuff, and a longer duration of comestibility upon refrigerated storage) and can be provided directly to consumers (i.e., as is or included within a package such as a paperboard box). Furthermore, the treated package can be heated by a user in a microwave oven. As the microwave-treated package heats, water vapor or other gases that are developed upon heating can pressurize the package and cause the seal to rupture. Following microwave treatment, the heated foodstuff can be eaten or served by removing it from the package, such as through the ruptured seal. In one embodiment, the materials and methods used to form the perimeter seal are selected to yield a peelable seal, such that the lidding film (including the now-ruptured seal) can be removed substantially intact from the tray, and the heated foodstuff can be served in the tray.

For packages which include a pressure-rupturable seal and that will be subjected to HPP treatment in a sealed configuration, it is important that the materials, construction, package contents, and HPP treatment be selected such that HPP-treatment of the sealed package will not rupture the seal. For example, packages which contain substantial amounts of a compressible fluid (e.g., air or a modified atmosphere) can deform upon the compression that occurs during HPP treatment, and such deformation can rupture or significantly weaken rupturable seals. A skilled artisan is able to determine (e.g., empirically) appropriate amounts of compressible fluid that can be retained within a sealed package for any combination of materials, construction, package geometries, package contents, and HPP treatment.

In one embodiment, the package that is subjected to HPP treatment is either the same package that will be presented to consumers of the foodstuff (i.e., the retail package, having desired labels or printing thereon) or a package that can be conveniently mated with a retail package (e.g., a plastic pouch having a defined size and shape selected to mate with a cardboard or paper box, sleeve, or label).

Vacuum packaging (including partial vacuum packaging, such as is performed to remove only most gas or vapor from a package prior to sealing) is a preferred packaging method, because application of a lowered pressure to a foodstuff and subsequent increase in the pressure when the foodstuff contacts the microbistat-containing fluid can induce infusion of the fluid into the foodstuff Furthermore, many vacuum packaging techniques can readily incorporate HPP-compatible materials. Thus, a microbistat-containing fluid-contacted foodstuff packaged in an HPP-resistant package can be readily made and is highly compatible with the HPP treatment that is part of the methods that are disclosed herein. In a preferred embodiment, the foodstuff is packaged (either together with excess microbistat-containing fluid or having it infused within the foodstuff) in a flexible plastic pouch formed by fusion, lamination, or other assembly of two or more plastic sheets (or a single sheet, folded back upon itself) along a seam, the laminated sheets being separable along at least a part of the seam by peeling (i.e., the sheets can be peeled, and the container opened, using ordinary human strength). Alternatively, the laminated sheets can be fused, such that the interior of the package cannot practically be accessed other than by breaching at least one of the sheets.

The identity of the microbistat with which the foodstuff is packaged is not critical and its identity and concentration or amount should be selected such that the microbistat will inactivate substantially all VFCOs which remain (or are anticipated to remain) in the foodstuff following HPP treatment of the foodstuff. Selection of microbistats and effective amounts is relatively routine to a skilled artisan in view of this disclosure and with knowledge of the identity of the foodstuff, the identity of VFCOs that are present or likely present in the foodstuff, the HPP-sensitivity (pressure-sensitivity) of those VFCOs, and the approximate amounts of VFCOs anticipated to be present.

Any of a wide variety of known microbistats can be used, and multiple microbistats can be included within the package. Examples of known microbistats include bacteriocins (e.g., nisin), antimycotics (e.g., natamycin), and organic (e.g., acetic, citric, or lactic) or inorganic (e.g., hydrochloric and phosphoric) acids. One preferred type of microbistats are fermentate microbistats, which are mixtures of organic acid salts that are prepared by culture of certain bacteria known to produce bacteriocins and/or antimycotics when cultured on natural products such as simple sugars or skim milk. Typically, the producing organism is removed from or inactivated in commercial preparations of such fermentate microbistats. Commercially available samples of fermentate microbistats include PURAC FRESH S39 brand cultured acetic acid-sodium lactate mixture (Purac America, Inc., Lincolnshire Ill.), PURAC VERDAD RV75 brand cultured organic acid salt mixture (Purac America, Inc., Lincolnshire Ill.), MICROGARD 200 brand cultured dextrose product (DANISCO USA Inc., Madison Wis.), and MICROGARD 730 brand cultured dextrose product (DANISCO USA Inc., Madison Wis.). Many other fermentate microbistats are known and described in the art. Their use in packaged foodstuffs is known, but their use in packaged botanical foodstuffs that are subjected to HPP treatment has not previously been reported.

Advantages of fermentate microbistats used in food packaging as described herein include the facts that such microbistats have achieved widespread commercial acceptance in food products, that they satisfy some consumers' demands for natural products and ingredients in packaged food products, that they can be described on food labels using consumer-acceptable terms such as “cultured sugar,” and that they are highly amenable to inclusion in brines, sauces, syrups, and other fluids with which botanical foodstuffs can be readily packaged. Furthermore, as illustrated in the examples described herein, fermentate microbistats appear to retain their microbistatic effectiveness even after being subjected to HPP treatment.

HPP Treatment

In addition to being packaged with the microbistat-containing fluid, the foodstuff is also subjected to an HPP treatment. The precise nature of the HPP treatment employed is not critical. Substantially any HPP method known to inhibit VFCOs can be used. Preferably, an HPP method is selected that is known to be effective against the particular VFCO(s) known or expected to occur in the foodstuff being processed. HPP methods are well known and described in the art.

HPP equipment typically uses a working fluid, most commonly water. Such equipment typically includes a pressure chamber into which a foodstuff is placed. After loading (i.e., placement of the foodstuff within the pressure vessel), the chamber is filled with the working fluid, and the chamber is pressurized by application of a high hydrostatic pressure (e.g., 20-120 kpsi, more typically 35-87 kpsi) to the working fluid. Such pressurization of liquids and liquid-containing foodstuffs ordinarily results in adiabatic heating that is substantially reversed upon de-pressurization. It is known that such heating can be modulated (e.g., by controlling the temperature of the working fluid, such as by cooling it), and that such modulation can be beneficial for heat-sensitive foodstuffs. Such temperature modulation can be practiced in HPP techniques employed in the methods described herein. Alternatively, adiabatic heating (potentially supplemented by other heating) of HPP working fluid can be used as a further antimicrobial method for packaged foodstuffs that can withstand such heating without undesirable changes to comestibility.

Because pressure within a fluid in a chamber is uniform throughout the fluid, and because the working fluid in an operating HPP apparatus completely surrounds the foodstuff, the hydrostatic pressure within the chamber is applied isotropically (i.e., not in any particular direction more than another) to the foodstuff. So long as the foodstuff does not contain excessive compressible materials (e.g., gases such as air bubbles within the foodstuff and in headspace above the foodstuff; water and other fluids tend to be substantially incompressible at HPP pressures), the shape of the foodstuff tends not to be altered significantly (even though some microscopic changes may occur, such as denaturation of proteins within the foodstuff). Furthermore, foodstuffs that do not include portions capable of withstanding deformation at the applied pressure will also transmit the pressure within the foodstuff, the result being that the hydrostatic pressure applied to the chamber occurs throughout the treated foodstuff.

Maintenance of the foodstuff at the applied pressure results in damage to VFCOs (e.g., bacteria, molds, yeast, and parasites) that may be present on or within the foodstuff. Regardless of the precise nature of the damage, VFCOs (other than pressure-insensitive forms of VFCOs, such as bacterial spores and protozoan cysts) subjected to HPP treatment appear to replicate and metabolize at substantially lower rates than non-HPP-treated VFCOs. This effect is the primary basis for the desirability of HPP treatment of foodstuffs.

The HPP technique should ideally be selected to be sufficient to render all pressure-sensitive VFCOs non-viable throughout the foodstuff after the foodstuff is subjected to the HPP technique. More practically, the technique should be selected such that no more than a small, selected number of VFCOs reasonably anticipated to be present in the foodstuff to be processed are rendered non-viable by the treatment. In practice, a five-, six-, seven-, or eight-log reduction in VFCOs is often considered adequate. The expected effectiveness of an HPP treatment method will also depend on the identity and form of the foodstuff, the identity and nature of VFCOs that can reasonably be anticipated to be present in the foodstuff, the nature of any packaging containing the foodstuff, the temperature of the foodstuff, and other factors within the ken of a skilled artisan in this field. Methods of assessing and enumerating VFCOs and appropriately safe and desirable levels of such organisms are known to or determinable by a skilled artisan in the field of food microbiology.

By way of example, it can be desirable to select an HPP technique that yields a foodstuff in which substantially no vegetative growth of the FCOs can be detected when the foodstuff is stored in the dark at 4 degrees Celsius for 10 days after having been subjected to the HPP technique. Alternatively, this assessment can be made at other temperatures (e.g., at an ambient environmental temperature such as 20 degrees Celsius) and for different periods (e.g., by performing the assessment at 30 days, 3, 6, or 9 months, or at 1, 2, or 3 years). Alternatively, the HPP technique and parameters can be selected to effect a five+ log reduction in the treated sample (i.e., the load of pressure-sensitive VFCOs in the sample is reduced by a factor of 100,000 or more by the HPP treatment). As a skilled artisan in this field understands, the precise assessment used and corresponding acceptable degree of effectiveness can be selected based on the identity of the foodstuff, the identity of pressure-sensitive VFCOs known or expected to be present in the foodstuff, the expected conditions and duration of storage, and other characteristics within the ken of a skilled artisan in this field.

Certain types of FCOs (e.g., certain bacteria and spores) are known to be relatively pressure-insensitive and therefore less affected by HPP treatment than other FCOs that are known to be HPP-sensitive. Furthermore, the Examples herein demonstrate that yeasts, molds, and certain bacteria such as lactic acid-producing bacteria (e.g., those of the genus Lactobacillus) exhibit substantial pressure-resistance, in that many remain viable following HPP treatment. Depending on the extent to which pressure-insensitive FCOs are known (e.g., through empirical microbiological testing) or suspected (e.g., on account of observed contamination with a source or such organisms) to be present in a botanical foodstuff, a suitable microbistat can be employed to inactivate (i.e., at least reduce the viable fraction of) the pressure-insensitive FCOs known or suspected to be present, thereby reducing the corresponding health and spoilage threats. Similarly, one or more supplemental antimicrobial treatments suitable for inactivating non-pressure-sensitive VFCOs can be employed in combination with the HPP treatment and microbistat-containing packaging.

At least two types of supplemental antimicrobial treatments are suitable for enhancing the antimicrobial efficacy of the processes described herein: heat treatments and contacting the treated vegetable or foodstuff with an antimicrobial agent.

Heat Treatments

In order to supplement VFCO inactivation attributable to HPP treatment and/or microbistat contact, a botanical foodstuff can be subjected to one or more heat treatments.

The role of the heat treatment is to achieve occurrence of temperature conditions sufficient to exert an antimicrobial effect on any pressure-insensitive forms of VFCOs that may be present in the foodstuff. For that reason, the antimicrobial temperature conditions need not be induced throughout the entire foodstuff, but instead throughout at least the portions of the foodstuff in which pressure-insensitive VFCOs occur.

For many whole vegetables (and slices thereof), microbial populations occur substantially only on natural or cut surfaces of the vegetables. Thus, for many vegetables, achievement of antimicrobial temperature conditions only at or near (i.e., within a millimeter or two) of the vegetable surfaces can be sufficient to induce an antimicrobial effect sufficient to achieve a significant (i.e., 3- to 8-log) reduction in pressure-insensitive VFCOs in such vegetables. Methods such as blanching, steaming, and radiant exposure to high heat can be used to substantially reduce pressure-insensitive VFCOs without necessarily heating the bulk of the vegetable. If such treatment is followed by rapid quenching (e.g., in a chiller or by immersion in a cold fluid, such as ice water), the temperature within the bulk of a vegetable piece can be further controlled, so as to avoid internal heating of the vegetable and concomitant loss of desirable organoleptic properties. Blanching, for example, can be performed by heating cut vegetable pieces to 150-175 degrees Fahrenheit for a period of 30 seconds to 10 minutes. Cooking, for example in boiling water for 8-12 minutes, can reduce the viable fraction of FCOs present in cut, human-bite-sized vegetable pieces.

Whether the heat treatment has any effect on non-pressure-insensitive forms of VFCOs is relatively immaterial, as such forms will be inhibited by the HPP technique to which the foodstuff is subjected.

An appropriate heat treatment should be selected to reduce the level of VFCOs that are known to be or are foreseeably present in the foodstuff being processed. A wide variety of antimicrobial heat treatments are known in the art, and substantially any of these can be selected and used in the processes described herein. A skilled artisan in this field understands how the identity, intensity, and duration of various heat treatments affect the antimicrobial efficacy of the heat treatment. Such an artisan is able to select an appropriate treatment to complement the HPP processes described herein based in the information provided in this disclosure. Non-limiting examples of such heat treatments include retorting, blanching, steaming, boiling, frying, sautéing, deep-frying, microwave irradiation, and the like. Where preservation of heat-labile organoleptic properties is desired, heating methods that rapidly bring VFCO-containing portions (e.g., surfaces) of vegetables or vegetable-containing foodstuffs to antimicrobial temperatures without necessarily significantly increasing the temperature of other portions of the vegetable or foodstuff are desirable, such as blanching followed rapidly by quenching in ice water.

The precise criteria required to achieve antimicrobial heating effect vary depending on the identity of the VFCOs, the identity and characteristics of the substrate within the VFCOs occur, the nature and mechanism of heat application, and the like. These criteria are well-reported in the food processing arts, and their application to any of the processes described herein is within the ken of a skilled artisan, in view of the guidance provided herein.

Contacting Vegetables with One or More Antimicrobial Agents

In order to supplement VFCO inactivation attributable to HPP treatment and microbistat contact, a foodstuff can be contacted with one or more antimicrobial agents.

A wide variety of antimicrobial agents are known in the food processing arts, and substantially any of these can be used in the processes described herein. Selection of an antimicrobial agent for use in a food processing method requires consideration of the potential health effects of the agent, its effects on treated food, and potential interactions among agents when multiple agents are used. However, these considerations are routine and well studied in this field, and a skilled artisan is able to select appropriate antimicrobial agents for a particular foodstuff and processing method without any more than routine empirical trials.

Because botanical foodstuffs tend to be irregularly shaped (and/or contain irregularly-shaped botanical pieces), antimicrobial agents are often contacted with such foodstuffs as fluids, in fluid solutions, or as suspensions in fluids. Substantially any fluid (i.e., liquid or gas) that is or includes an antimicrobial agent can be used in the methods described herein. The role of the fluid in the methods is to achieve occurrence of one or more antimicrobial agents throughout the foodstuff (or at least at portions of the foodstuff at which VFCOs occur or can be expected to occur) at level(s) that are sufficient to exert an antimicrobial (i.e., inactivating) effect on any pressure-insensitive forms of VFCOs that may be present in the foodstuff. Whether the antimicrobial agent has any effect on non-pressure-insensitive forms of VFCOs is relatively immaterial, as such forms will be inhibited by the HPP technique to which the foodstuff is subjected.

In one embodiment, the process of contacting the foodstuff with the fluid is, by itself sufficient (i.e., regardless of whether the HPP technique is performed) to achieve antimicrobial agent levels that inhibit pressure-insensitive forms of at least one (and preferably all) VFCOs present in the foodstuff, throughout the foodstuff or, at least, throughout all portions of the foodstuff at which occurrence of such forms can reasonably be expected and which can be reasonably expected to be eaten by a consumer.

Merely contacting a foodstuff with the fluid, by itself, may not achieve sufficient antimicrobial agent levels throughout the relevant portions of the foodstuff. Such levels can be achieved in combination with performance of the HPP technique. For example, for a botanical foodstuff that may harbor VFCOs internally (i.e., not at or near the surface thereof), it is sufficient if contacting with the fluid results in a high surface layer concentration of the agent, but a relatively low concentration (or substantially none of the agent) in the interior thereof the foodstuff, so long as the agent diffuses, convects, or is forced into the interior portion (or at least into whichever parts VFCOs may occur) by the time the HPP technique is completed, or relatively soon thereafter (i.e., such that the sufficient pressure-insensitive-form-inhibitory level of the agent is achieved internally.

Numerous methods of contacting a foodstuff with a fluid are known, and substantially any can be used to contact the foodstuff with an antimicrobial agent-containing fluid. By way of example, the foodstuff can be rinsed, soaked, immersed, intermittently sprayed, or depressurized-and-repressurized (e.g., undergo vacuum infusion) in the presence of the fluid, whether the fluid be gaseous or liquid. Preferably, the fluid is a liquid that is or contains an antimicrobial agent, such as an aqueous solution of a comestible acid, such as acetic, citric, or tartaric acid, a table or sea salt solution, a bacteriocin, or a non-comestible agent such as chlorine or ozone gas or peracetic acid, or a combination of these. By way of example, a relatively porous foodstuff (e.g., cooked rice or boiled potatoes) can simply be soaked in such a fluid, so that the agent diffuses throughout the foodstuff.

A botanical foodstuff can be contacted with an antimicrobial agent that is not comestible, or an agent which has a taste or other organoleptic effect that is undesirable (e.g., sour or metallic aftertaste or inducement of pain at intraoral lesions). In such instances, however, the agent should be partially, substantially, or substantially completely removed from the vegetable or foodstuff after a period sufficient for the agent to exert its antimicrobial effect on the foodstuff. By way of example, chlorine gas and peracetic acid are efficacious antimicrobial agents, but are not appropriate components of a food at the time of its consumption by a human, at least at substantial concentrations. However, each of these agents can be substantially eliminated from a foodstuff after its use for antimicrobial purposes. Chlorine gas, for example can be vented or removed by vacuum and any residual chlorine gas can be reacted with food components to form harmless compounds. Similarly, peracetic acid can be rinsed from treated food or thermally degraded to harmless compounds after it has exerted its antimicrobial effect. Thus, non-comestible antimicrobial agents can be used in the processes described herein, so long as they are removed or rendered harmless prior to consumption of the treated foodstuff.

In a preferred method of infusing an antimicrobial agent-containing fluid into a food article such as a vegetable piece or a more-structured botanical foodstuff, the food article and the fluid are contacted at a reduced pressure, such as at a sub-atmospheric pressure. Preferably, the article and the fluid are contacted prior to reducing the pressure. Upon pressure reduction, air (or another gas) in any voids within the article expands and tends to be released from the article. Either immediately or upon decreasing the pressure, fluid on the surface of the article, in a surface layer of the article, or in which the article is immersed can replace the escaping gas, resulting in infusion of the fluid into the article. Regardless of the mechanism by which this infusion occurs, such methods (e.g., vacuum infusion) are well known in the art to result in incorporation of liquid into article such as fruits and vegetables.

In one preferred embodiment, the antimicrobial agent-containing fluid takes the form of a sauce intended for consumption with the food article, such as a cheese-containing or -flavored sauce that is consumed together with (i.e., as an accompaniment to or infused within) a vegetable. In this embodiment, the sauce can be formulated to include the agent(s) and can be both infused into the food article and present within a package containing the food article in a controlled or relatively non-controlled excess amount. By way of example, the food article can be packaged to include an amount of sauce that is proportional to the weight of the article or to the volume of the article. Alternatively, the food article can be packaged so that the package contains no excess sauce beyond the amount infused into the article. The sauce can contain both the microbistat and a supplemental antimicrobial agent.

In another embodiment, the foodstuff is contacted with an antimicrobial agent-containing fluid at a concentration and for a period of time sufficient to achieve effective antimicrobial agent(s) levels on and within the foodstuff, and is thereafter packaged with a different fluid (e.g., a sauce or cooking fluid). The different fluid may contain the same agent(s), one or more different antimicrobial agents, or no antimicrobial agents. When agent-infused food articles are contacted with a fluid other than the antimicrobial agent-containing fluid, care should be taken to ensure that agent levels within the article are maintained at levels adequate to inhibit pressure-insensitive pathogens that may be present in the article throughout the expected period of contact between the article and the other fluid, especially if the antimicrobial agent acts as by inhibiting growth, proliferation, or germination of a pathogen (i.e., rather than killing it outright). By way of example, it is known that some foodstuffs (e.g., certain fruit and vegetable pieces) will exude liquid (“weep”) upon storage, cooking, or both. Antimicrobial agent levels should be selected to account for any such weeping that can be anticipated. The necessary calculations and considerations to achieve this are within the ken of a skilled artisan in this field.

It is not critical which antimicrobial agent(s) are used in the methods described herein. The identity and amount of the agent(s), as well as its method of infusion into or contact with the food article should be selected such that, after such infusion or contact, the agent(s) is present at a sufficient level that it can exert its antimicrobial effect sufficiently to enhance the storage stability (or decrease the pressure-insensitive microbial load) by the desired amount.

The foodstuff can be contacted with the antimicrobial agent-containing fluid prior to or after subjecting the foodstuff to an HPP treatment. Preferably, the contact precedes HPP treatment because this processing order can facilitate packaging and subsequent handling of the food article. The article-to-fluid contacting step can be performed before or after packaging of the article, simultaneously therewith, after insertion of the article into a package but prior to sealing of the package, or a combination of these. By way of example, a vegetable piece can be soaked in the fluid prior to packaging, the piece and the fluid (including both the antimicrobial agent and the microbistat) can be packaged together, and the contact between the fluid and the piece can continue after packaging. Alternatively, the fluid can be vacuum infused (i.e., at a sub-atmospheric pressure) into a vegetable piece, the piece having the liquid infused therein can be packaged (with or without combination with other foodstuff components) at atmospheric pressure without excess liquid, and the packaged piece can thereafter be subjected to the HPP technique.

In the examples described herein, fermented sugar products marketed by Purac America, Inc. (Lincolnshire Ill.) and DANISCO USA Inc. (Madison Wis.) were used as a source of antimicrobial bacteriocins and antimycotics. These compounds are suitable for use both as microbistats and as supplemental antimicrobial agents. A skilled artisan recognizes that bacteriocins and antimycotics are available from a wide variety of sources and in a variety of forms and levels of purity. For the purposes described herein, the bacteriocins and antimycotics should be comestible if they are to be packaged and consumed with the botanical foodstuff. Non-comestible bacteriocins and antimycotics can be used to treat botanical foodstuffs, so long as they are substantially removed (at least to comestible levels) prior to consumption of the foodstuff, such as by removing a bacteriocin- or antimycotic-containing preparation prior to sealing the foodstuff in a package or by removing the preparation from the packaged foodstuff (e.g., by rinsing with water) prior to consumption of the foodstuff. Preferably, a bacteriocin- and/or antimycotic-containing preparation is packaged with a botanical foodstuff during any period of extended storage, so that the bacteriocin/antimycotic can exert its anti-pathogen and/or anti-spoilage effect(s) throughout the extended storage period. Bacteriocins and antimycotics known or generally regarded as safe for use in foodstuffs are well known in the art, and substantially any of these can be used in the processes described herein.

Storage Stability

Ideally, the botanical foodstuff is processed as described herein sufficiently to completely eliminate any health risk to an ordinary consumer (i.e., one who exhibits normal immune responses and tolerance for ingesting low levels of pathogenic organisms without becoming ill) arising from survival, growth, proliferation, or germination of a FCO in the article, so long as the article is refrigerated, and to reduce the spoilage characteristics of any FCO that may be present in the foodstuff prior to such processing. Practically speaking, no food processing method can completely eliminate all risk of microbiological pathogenicity and spoilage, and food microbiological safety is typically assessed with reference to the likelihood of pathogenic events or spoilage levels or (more objectively) to reduction in the number of VFCOs that remain in a foodstuff following a treatment.

The processes described herein can be selected and performed such that the VFCO load of the processed foodstuff is reduced sufficiently that the foodstuff remains microbiologically safe for consumption by an intended consumer (e.g., a normal, healthy human, and preferably even by an immunocompromised or ill human) for a period of at least several months, provided the foodstuff is refrigerated (i.e., maintained at a temperature not greater than 6 degrees Celsius, and preferably not greater than 4 degrees Celsius, other than for brief periods of second, minutes, or hours corresponding to ordinary transfers of the foodstuff from one refrigeration unit to another). The processes can, of course, be practiced to provide lesser increase in storage stability, relative to a non-processed foodstuff. The processes preferably yield foodstuffs that are microbiologically safe for consumption as intended for at least one week, one month, or four, six, eight, ten, twelve, or eighteen months (or even longer), so long as the article is refrigerated substantially continuously between the time of processing and the time of preparation for consumption (i.e., other than for brief periods, such as times attributable to transfer between a refrigerated truck and a refrigerated warehouse or to transfer between a retail point of sale and a consumer refrigerator).

Similarly, the processes described herein can be selected and performed such that the VFCO load of the processed foodstuff is reduced sufficiently that the foodstuff does not exhibit spoilage characteristics (e.g., off-tastes, off-colors, visible FCO growth, or presence of substantial amounts of gas or vapor formed within the foodstuff package) for a period of at least several months, provided the article is refrigerated (i.e., maintained at a temperature not greater than 6 degrees Celsius, and preferably not greater than 4 degrees Celsius, other than for brief periods of second, minutes, or hours corresponding to transfer of the foodstuff from one refrigeration unit to another). The processes can, of course, be practiced to provide lesser increase in storage stability, relative to a non-processed foodstuff. The processes preferably yield articles that remain non-spoiled for at least one week, one month, or four, six, eight, ten, twelve, or eighteen months (or even longer), so long as the article is refrigerated substantially continuously between the time of processing and the time of preparation for consumption (i.e., other than for brief periods, such as times attributable to transfer between a refrigerated truck and a refrigerated warehouse or to transfer between a retail point of sale and a consumer refrigerator). A skilled artisan recognizes that desirable storage periods vary for different food articles and that various food articles may become practically non-comestible upon extended storage for reasons other than spoilage attributable to the presence or action of FCOs.

Another method of assessing the sufficiency of processing of foodstuffs accomplished as described herein is by observing the level of VFCOs present in the foodstuff before and after the foodstuff is subjected to the processing. Preferably, the processes described herein reduce the number of VFCOs of at least one type (e.g., at least viable E. coli strain 0157:H7, S. cerevisiae organisms, or C. botulinum spores) by at least a factor of 100,000 (known in the art as a “five-log reduction”), and preferably by a six-, seven-, or eight-log reduction, relative to an identical sample that is not subjected to the process. More preferably, the processes elicit at least a five-log reduction in the number of each of multiple VFCOs (even more preferably, all VFCOs). A skilled artisan in this field appreciates that different enumeration methods are used for different FCOs, and that selection of an appropriate enumeration method is within the ken of a skilled artisan in view of the type and characteristics of the food article to be analyzed, the organism to be assessed, and other routine factors. By way of example, if it can be anticipated that storage and handling of a packaged foodstuff will likely vary from ideal storage conditions (e.g., military or emergency relief rations for which refrigeration may not be consistently available toward the end of the anticipated storage period), then the assessments used should take into account the conditions to which the packaged foodstuff may be exposed.

The Foodstuff

The methods disclosed herein are useful for processing a wide variety of botanical foodstuffs. The processes are suitable for extending the storage stability, storage life, and microbiological safety of fruits, vegetables, fungi, and foodstuffs which contain them. Liquid foodstuffs (e.g., fruit and vegetable juices, soups, stocks, dressings, sauces, and frozen dessert precursors) and liquid-containing foodstuffs (e.g., fruits, vegetables, pastes, baby foods, and pastas), for example, are also highly suitable for processing as described herein. Botanical foodstuffs may contain non-botanical ingredients, such as meats (e.g. a foodstuff useful for filling tacos, the foodstuff containing cut or ground chicken or beef, cut vegetables, and seasonings). Foodstuffs having gaseous inclusions (e.g., breads, mousses, and crackers) are generally unsuitable for the processes described herein (or for any HPP method, for that matter, on account of the compressing effects of such treatments), although ingredients (e.g., flours, sugars, and non-yeast-containing doughs) for making such foodstuffs can be processed herein.

When used to treat vegetables or other botanical foodstuffs, the identity of the ultimate consumer is essentially immaterial, except to the extent that it may affect the desired level of microbiological safety of the product. Products intended for human consumption will generally have more stringent requirements for microbiological safety than those intended for consumption by non-human animals. Furthermore, certain populations of humans (e.g., hospitalized patients or those known to have weakened immune systems) may require foods having greater microbiological safety than others. A skilled artisan is able to use the guidance provided herein to select process components and criteria sufficient to achieve substantially any desired degree of microbiological food safety.

Microbiological growth is considered desirable in some foods (e.g., pickles) that are stored under refrigerated conditions. Such foods are often susceptible to contamination with microorganisms that are not intended or desired to survive or proliferate therein. The methods described herein can be used to select for desired organisms and against undesired FCOs in such products. If the desired organisms are pressure-insensitive, then the processes described herein can be employed simply by subjecting the food to the process, selecting a microbistat and any supplemental antimicrobial treatment(s) that do not substantially inactivate the desired organism(s) but which do substantially inactivate non-desired VFCOs. When the desired organism(s) are pressure-sensitive, then the organisms should be added after the HPP step (e.g., from pure or mixed cultures of desired organisms), and the identity and timing of the microbistat and any supplemental antimicrobial treatment(s) should be carefully selected to preserve the desired organisms while inactivating any VFCOs known to be present or at risk of being present as a result of HPP-resistance or desired-organism-addition.

It is well known that the effective storage life of many foodstuffs (i.e., the period of time that an article can be safely maintained at a storage condition while retaining comestibility or utility as a comestible ingredient) can be extended by refrigeration. In addition to slowing the rate of abiotic chemical reactions that can lead to incomestibility, refrigeration also reduces the rates of microbial growth and proliferation and of conversion of spores and cysts to vegetative forms. Because microorganisms generally proliferate by division, their growth-in-number proceeds logarithmically, rather than linearly, in proportion to their initial numbers. Because HPP, the microbistat, and supplemental antimicrobial treatment as described herein can dramatically decrease VFCOs present in a foodstuff, such treatment coupled with refrigeration can dramatically extend the effective storage life of food articles.

The techniques described herein are also beneficial in that they facilitate packaging of foodstuffs such as vegetables and fruits together with a sauce or other liquid, with the amount of sauce packaged with the article being readily controllable. For example, the techniques can be used to package cut green beans, pearl onions, and rice having a flavor included in an antimicrobial agent-containing liquid infused into the beans, onions, and rice (or different flavored liquids infused into each) but no free liquid upon opening the package. Similarly, the techniques can be used to package cut cauliflower florets having an antimicrobial agent-containing liquid infused therein and also having a comestible sauce packaged therewith (with the level of agent infused into the florets being selected to account for expected diffusion into the co-packaged sauce over time with storage) such that a ready-to-eat sauced cauliflower dish can be prepared merely by contacting the package with boiling water (or heating it in a microwave oven) for several minutes prior to peeling or cutting open the package and pouring its contents onto a serving dish or dinner plate. Each of these packaged products can be stored, with or (in some instances) without refrigeration, for days, weeks, or months.

### EXAMPLES

The subject matter of this disclosure is now described with reference to the following Examples. These Examples are provided for the purpose of illustration only, and the subject matter is not limited to these Examples, but rather encompasses all variations which are evident as a result of the teaching provided herein.

Methods

The following methods were used in the various examples disclosed herein.

Two botanical foodstuff samples were used, one designated garden vegetable salad (GVS), and the other designated green beans-and-potatoes (GBP).

GVS samples consisted of approximately 57 grams of a vegetable mixture and approximately 43 grams of a dressing in every 100 grams of GVS sample. The vegetable mixture consisted of five vegetables: broccoli florets (28 wt %, approximately 1.5 inch florets, blanched at 170 degrees Fahrenheit for two minutes), cherry tomatoes (24 wt %, approximately 1-1.5 inch diameter, rinsed with water containing 50 parts per million of chlorine), carrots (23 wt %, approximately 1-1.5 inch long julienned strips, blanched at 170 degrees Fahrenheit for one minute), yellow bell pepper (18 wt %, approximately 1-1.5 inch long julienned strips, blanched at 170 degrees Fahrenheit for one minute), and jicama (7 wt %, cut into approximately 0.75-inch cubes and blanched at 170 degrees Fahrenheit for one minute). The dressing consisted of a mixture of water (about 76 wt %), a vegetable oil (15 wt %), balsamic vinegars (4.5 wt %, 60 grain), pureed (1.3 wt %) and minced acidified (1.2 wt %) garlic, table sugar (1.2 wt %), table salt (0.75 wt %), and xanthan gum, ground black pepper, chopped parsley, and hydroxylated lecithin (≦0.25 wt % each).

To produce GVS samples containing various additives, sufficient dressing to make 40 individual samples was combined with the selected amount of the additive(s), and the combination was blended using an Iverson mixer to ensure complete solubilization and/or mixing of the dressing and additive(s). The amounts of additives used were: PURAC FRESH S39 brand cultured acetic acid-sodium lactate mixture (Purac America, Inc., Lincolnshire Ill.), 0.5 gram per 100 gram sample; PURAC VERDAD RV75 brand cultured organic acid salt mixture (Purac America, Inc., Lincolnshire Ill.), 0.75 gram per 100 gram sample; MICROGARD 200 brand cultured dextrose product (DANISCO USA Inc., Madison Wis.), 0.5 gram per 100 gram sample; MICROGARD 730 brand cultured dextrose product (DANISCO USA Inc., Madison Wis.), 0.75 gram per 100 gram sample. The PURAC VERDAD RV75 and MICROGARD 730 products are believed to contain one or more bacteriocins that are effective at least against Lactobacillus species. The PURAC FRESH S39 and MICROGARD 200 products are believed to contain one or more antimycotics that are effective at least against S. cerevisiae.

GBP samples consisted of approximately 39 grams of a vegetable mixture and approximately 61 grams of a brine in every 100 grams of GBP sample. The vegetable mixture was about 70:30 (by weight) green beans:potatoes. Green beans were cut into approximately 1.5-inch lengths and potatoes were cut into approximately 0.75-inch cubes cut from peeled white potatoes prior to combination with the brine. The brine consisted of 83.7 wt % water, 10.6 wt % granulated table sugar, 3.4 wt % 120 grain vinegar, 1.8 wt % table salt, and 0.5 wt % of a sensory enhancer (SMOOTHENOL brand product, Sensient Technologies Corporation, Milwaukee, Wis.).

To produce GBP samples containing various additives, sufficient brine to make 35 individual samples was combined with the selected amount of the additive(s), and the combination was blended using an Iverson mixer to ensure complete solubilization and/or mixing of the brine and additive(s). The amounts of additives used were: PURAC FRESH S39 brand cultured acetic acid-sodium lactate mixture (Purac America, Inc., Lincolnshire Ill.), 0.5 gram per 100 gram sample; PURAC VERDAD RV75 brand cultured organic acid salt mixture (Purac America, Inc., Lincolnshire Ill.), 0.75 gram per 100 gram sample; MICROGARD 200 brand cultured dextrose product (DANISCO USA Inc., Madison Wis.), 0.5 gram per 100 gram sample; MICROGARD 730 brand cultured dextrose product (DANISCO USA Inc., Madison Wis.), 0.75 gram per 100 gram sample.

Where indicated in individual Examples herein, the bulk GVS and GBP samples were acidified to a low pH (effective sample pH was about 4.3-4.5) and/or retorted to achieve sterilization. The bulk samples were divided into aliquots (approximately 4 fluid ounce aliquots for Example 1; approximately 100 gram aliquots for Examples 2-4) and individually packaged in plastic cups having a flexible lidstock (Example 1) or in flexible polyethylene pouches (Examples 2-4) after preparation of the bulk sample. For Examples 1, each cup included a septum formed on the lidstock of the cup using a silicone-based gel adhesive that was allowed to cure for 48 hours prior to use. The septum facilitated inoculation of test organisms into the individual sample cups (i.e., preventing leaking and contamination following inoculation through a needle that pierced the septum and the underlying portion of the lidstock). For examples 2-4, individual pouches were inoculated with test organisms prior to vacuum-sealing the pouch.

In Examples in which HPP treatments were performed, HPP treatment was applied using a WAVE 6000/55 brand HPP machine (NC Hyperbarics, Burgos Spain), generally at a chamber pressure of 540 or 600 megaPascals (MPa; 640 MPa=ca. 87,000 pounds per square inch) using water as a working fluid and for a residence time of 2-9 minutes, except as otherwise noted.

Test Organisms

The following test organisms and culture, enrichment, and detection techniques were used in the examples, except as otherwise noted.

Escherichia coli 0157:H7 stx⁻ (hereinafter E. coli) is a non-pathogenic variant of the known human pathogenic (shiga-toxin-producing, i.e., stx⁺) strain, the stx⁻ strain being a strain that does not produce the shiga toxin to which human pathogenicity is attributable. E. coli for inoculation was grown in suspension culture to a density of approximately 10,000 colony forming units/milliliter (CFU/ml) in brain heart infusion (BHI) broth maintained at 37 degrees Celsius for about 24 hours. For detection on selective medium, samples were plated on standard trypticase soy agar plates supplemented with kanamycin and cultured at 37 degrees Celsius for about 24 hours prior to colony enumeration. For enrichment, an aliquot of sample homogenate was suspended in buffered peptone water and incubated overnight at 37 degrees Celsius. Aliquots of the incubated suspension were streaked onto MacConkey agar plates supplemented with sorbitol, cefixime, and tellurite (CT-SMAC plates) and incubated at 37 degrees Celsius for about 24 hours.

One or more non-pathogenic Salmonella sero-species were used as a model of pathogenic Salmonella (e.g., those known as S. enteritidis, S. typhimurium, and S. cholerasuis). Salmonella for inoculation was grown in suspension culture to a density of approximately 10,000 CFU/ml in BHI broth maintained at 37 degrees Celsius for about 24 hours. For detection on selective medium, samples were plated on standard xylose-lysine-deoxycholate (XLD) agar plates and cultured at 37 degrees Celsius for about 24 hours prior to colony enumeration. For enrichment, an aliquot of sample homogenate was suspended in buffered peptone water and incubated overnight at 37 degrees Celsius. Ten-milliliter aliquots of the incubated suspension were spotted onto semisolid RV medium plates, and those plates were incubated at 42 degrees Celsius for about 16 hours. Following this incubation, diffuse white colonies from the plates were sub-cultured onto XLD plates that were incubated at 37 degrees Celsius for about 24 hours as confirmation of the presence of Salmonella.

Listeria innocua, a non-pathogenic Listeria species, was used as a model for pathogenic Listeria, such as L. monocytogenes, which L. innocua is known to closely resemble. L. innocua for inoculation was grown in suspension culture to a density of approximately 10,000 CFU/ml in BHI broth maintained at 37 degrees Celsius for about 24 hours. For detection on selective medium, samples were plated on standard Listeria Oxford agar plates and cultured at 30 degrees Celsius for about 48 hours prior to enumeration. For enrichment, an aliquot of sample homogenate was suspended in Listeria enrichment broth and incubated at 30 degrees Celsius for about 48 hours. Aliquots of the incubated suspension were subcultured onto Oxford formula agar plates, and those plates were incubated at 30 degrees Celsius for about 48 hours as confirmation of the presence of Listeria.

A mixture of Lactobacillus plantarum and Lactobacillus brevis (each a known spoilage organism) was used as a test organism mixture representative of lactobacilli. The Lactobacillus species were grown in suspension culture to a density of approximately 10,000 CFU/ml in deMan, Rogossa and Sharpe (MRS) broth maintained at 30 degrees Celsius for about 48 hours. For detection on selective medium, samples were plated on MRS agar plates and cultured under anaerobic conditions at 30 degrees Celsius for about 72 hours prior to enumeration. For enrichment, an aliquot of sample homogenate was suspended in MRS broth and incubated under an anaerobic atmosphere at 30 degrees Celsius for about 72 hours. Aliquots of the incubated suspension were streaked onto MRS agar plates, and those plates were incubated anaerobically at 30 degrees Celsius for about 72 hours as confirmation of the presence of Lactobacillus species.

The yeast Saccharomyces cerevisiae (a known food spoilage organism) for inoculation was grown in suspension culture to a density of approximately 10,000 CFU/ml in potato dextrose broth maintained at 25 degrees Celsius for about 48 hours. For detection on selective medium, samples were plated on standard yeast extract-peptone-glucose (YPD) agar plates and cultured at 25 degrees Celsius for about 120 hours prior to colony enumeration. For enrichment, an aliquot of sample homogenate was suspended in potato dextrose broth and incubated aerobically at 20 degrees Celsius for about 5 days. Aliquots of the incubated suspension were streaked onto potato dextrose agar plates and incubated at 25 degrees Celsius for about 120 hours to confirm the presence of yeast.

Bacillus coagulans is a known spoilage organism and was used as a model of spore-forming spoilage organisms. B. coagulans spores were produced on nutrient agar maintained at 30 degrees Celsius for about 14 days. Prior to inoculation, spores were heat treated at 60 degrees Celsius for 10 minutes. For detection on selective medium, samples were heat treated at 60 degrees Celsius for 10 minutes and then plated onto plated onto Bacillus agar plates and cultured at 30 degrees Celsius for about 48 hours prior to colony enumeration.

Clostridium sporogenes was used as a model of spore-forming pathogens such as C. botulinum. C. sporogenes spores were produced on Clostridium agar maintained at 30 degrees Celsius for about 14 days. Prior to inoculation, spores were heat treated at 60 degrees Celsius for 10 minutes. For detection on selective medium, samples were heat treated at 60 degrees Celsius for 10 minutes and then plated onto plated onto Clostridium agar plates and cultured anaerobically at 30 degrees Celsius for about 48 hours prior to colony enumeration.

One or more Penicillium species (including P. italicum) were used as a test organism representative of molds. Species for inoculation were grown in suspension culture to a density of approximately 10,000 CFU/ml in potato dextrose broth maintained at 25 degrees Celsius for about 48 hours. For detection on selective medium, samples were plated on YPD agar plates and cultured at 25 degrees Celsius for about 120 hours prior to colony enumeration. For enrichment, an aliquot of sample homogenate was suspended in potato dextrose broth and incubated aerobically at 20 degrees Celsius for about 5 days. Aliquots of the incubated suspension were streaked onto potato dextrose agar plates and incubated at 25 degrees Celsius for about 120 hours to confirm the presence of mold.

Staphylococcus aureus is a known human pathogen and was used as a test organism to model other known Staphyloccoccus pathogens. S. aureus for inoculation was grown in suspension culture to a density of approximately 10,000 CFU/ml in BHI broth maintained at 37 degrees Celsius for about 24 hours. For detection on selective medium, samples were plated on individual PETRIFILM STAPH EXPRESS brand (3M, St. Paul, Minn.) counting plates and cultured at 37 degrees Celsius for about 24 hours prior to colony enumeration. For enrichment, an aliquot of sample homogenate was suspended in buffered peptone water and incubated for about 24 hours at 37 degrees Celsius. Aliquots of the incubated suspension were streaked onto Baird Parker agar plates and incubated at 37 degrees Celsius for about 24 hours.

Total aerobic count analyses were performed according to standard methods, such as plating and incubation on standard plate count agar (tryptone-yeast extract-dextrose agar) at 34 degrees Celsius for about 48 hours prior to colony enumeration. For enrichment, an aliquot of sample homogenate was suspended in peptone and incubated at 34 degrees Celsius for about 24 hours. Aliquots of the incubated suspension were streaked onto standard plate count agar plates and incubated at 34 degrees Celsius for about 48 hours to confirm the presence of yeast.

### Example 1

Efficacy of HPP treatment for Botanical Foodstuff Samples Stored at Various Temperatures

The experiments described in this Example were performed to demonstrate the ability of several VFCOs to survive and, in some instances, increase in number in GVS and GBP samples stored at various temperatures.

Retort-sterilized GVS and GBP foodstuff samples were provided in relatively rigid plastic cups each sealed at one face with a thin, flexible plastic membrane bearing on its exterior face a septum formed from cured silicone-based adhesive. Each cup contained approximately 4 fluid ounces (i.e., ca. 120 milliliters) of one of the two samples. Each individual cup (other than controls) was inoculated with a one-milliliter aliquot of one of the test organism suspensions by way of a needle inserted through the septum. Inoculated cups and controls were stored in the dark for up to 90 days at one of three controlled temperatures. Some cups were stored at 25 degrees Celsius, others at 10 degrees Celsius, and still others at 4 degrees Celsius. The cups were made from two layers of polypropylene having a barrier (EVOH) layer adhered between them, and the membrane was made of an EVOH layer adhered between polypropylene and polyethylene terephthalate layers.

For each foodstuff sample, test organism type, and storage temperature, samples (typically three cups per sample) were withdrawn from storage and the test organisms therein were enumerated. Samples for enumeration were prepared by emptying the contents of a single cup into a sterile stomacher bag, adding an equal volume of neutralizing fluid, and operating the stomacher for 60 seconds to produce a sample homogenate. Dilutions, where necessary, were prepared by aliquoting the homogenate into sterile saline.

Test organisms in sample homogenates were enumerated using selective media for each individual test organism. In order to estimate sublethally-injured test organisms that might be unable to thrive on selective media, test organisms in samples were also enumerated by performing total aerobic count (TAC) assessments for all test organisms other than C sporogenes (an anaerobe) and Penicillium (a mold).

Aliquots of homogenate or a dilution thereof were plated onto the appropriate selective or TAC medium and incubated. If no colonies were detected, then the corresponding homogenate was enriched and plated onto the corresponding selective medium.

Enumeration results obtained for GVS samples stored at 4 degrees Celsius are presented in Table 1A. Results for GVS samples stored at 10 and 25 degrees Celsius are presented in Tables 1B and 1C, respectively. Results for GBP samples stored at 4, 10, and 25 degrees Celsius are presented in Tables 2A, 2B, and 2C, respectively. Abbreviations used in Tables 1A, 1B, 1C, 2A, 2B, and 2C are: CFU/g=colony forming units per gram; TAC=total aerobic count; SMC=selective medium count; ND=not detected; Ec=E. coli; Salm=Salmonella; Li=L. innocua; Sa=S. aureus; Lacto=Lactobacillus; Bc=B. coagulans; Sc=S. cerevisiae; Cs=C. sporogenes; Pen=Penicillium. Enumerated organisms values are alternately reported in two formats. Formats in which in which two numbers are separated by “±” represent enumeration values and their associated standard deviation. Formats in which two numbers are separated by a “/” represent the number of enriched samples which tested positive and the total number of enriched samples tested (e.g., “⅓” means one enriched sample was positive out of three enriched samples tested).

TABLE 1A
GVS Samples Stored at 4 degrees Celsius.

| | | Enumerated Organisms (log(CFU/g) or # positive/# tested) | | | |
|---|---|---|---|---|---|
| | | Day 0 | Day 28 | Day 60 | Day 90 |
| Ec | TAC | 3.21 ± 0.21 | 3.72 ± 0.00 | 2.00 ± 0.03 | 2.30 ± 0.11 |
| | SMC | 1.89 ± 0.15 | 2.33 ± 0.28 | 2.18 ± 0.28 | 1.72 ± 0.16 |
| Salm | TAC | 3.41 ± 0.20 | 4.66 ± 0.00 | 4.31 ± 0.06 | 3.54 ± 0.14 |
| | SMC | 3.94 ± 0.04 | 4.27 ± 0.09 | 2.95 ± 0.42 | 1.94 ± 0.36 |
| Li | TAC | 3.58 ± 0.05 | 2.11 ± 0.38 | ND | 4.19 ± 0.21 |
| | SMC | 3.05 ± 0.22 | 0/3 | 0/3 | 0/3 |
| Sa | TAC | 3.60 ± 0.06 | 3.45 | 4.24 ± 0.30 | 4.12 ± 0.20 |
| | SMC | 3.16 ± 0.08 | 1.45 ± 0.80 | 3/3 | 0/3 |
| Lacto | TAC | 2.09 ± 0.03 | 6.42 ± 0.00 | 7.17 ± 0.80 | 6.29 ± 0.24 |
| | SMC | 1.62 ± 0.29 | 5.89 ± 0.52 | 7.47 ± 0.29 | 6.38 ± 0.07 |
| Bc | TAC | 3.57 ± 0.25 | 0.90 ± 0.00 | 0.60 ± 0.03 | 2.34 ± 0.33 |
| | SMC | 2.91 ± 0.06 | 1.75 ± 0.10 | 0.80 ± 0.17 | 3.79 ± 0.02 |
| Sc | TAC | 3.70 ± 0.07 | 3.70 ± 0.25 | 3.51 ± 0.56 | 3.49 ± 0.81 |
| | SMC | 2.72 ± 0.02 | 5.37 ± 0.06 | 5.97 ± 0.06 | 6.08 ± 0.26 |
| Cs | SMC | 3.36 ± 0.21 | 3.10 ± 0.52 | 3.46 ± 0.33 | 3.06 ± 0.10 |
| Pen | SMC | 3.63 ± 0.05 | 2.82 ± 0.07 | 2.26 ± 0.24 | 1.55 ± 0.39 |

TABLE 1B
GVS Samples Stored at 10 degrees Celsius.

| | | Enumerated Organisms (log(CFU/g) or # positive/# tested) | | | |
|---|---|---|---|---|---|
| | | Day 0 | Day 7 | Day 14 | Day 28 |
| Ec | TAC | 3.21 ± 0.21 | 2.32 ± 0.01 | 2.36 ± 0.20 | 3.58 ± 0.25 |
| | SMC | 1.89 ± 0.15 | 2.36 ± 0.14 | 2.35 ± 0.09 | 2.22 ± 0.04 |
| Salm | TAC | 3.41 ± 0.20 | 4.68 ± 0.08 | 4.60 ± 0.10 | 3.45 ± 0.04 |
| | SMC | 3.94 ± 0.04 | 4.44 ± 0.06 | 4.60 ± 0.07 | 3.35 ± 1.18 |
| Li | TAC | 3.58 ± 0.05 | 0.91 ± 0.68 | 0.98 ± 0.37 | 1.62 ± 0.07 |
| | SMC | 3.05 ± 0.22 | 0.86 ± 0.54 | 0.92 ± 0.28 | 0/3 |
| Sa | TAC | 3.60 ± 0.06 | 4.67 ± 0.04 | 1.72 ± 0.39 | 3.30 ± 0.26 |
| | SMC | 3.16 ± 0.08 | 2.53 ± 0.10 | 2.63 ± 0.07 | 1.04 ± 0.72 |
| Lacto | TAC | 2.09 ± 0.03 | 5.75 ± 0.07 | 5.50 ± 0.07 | 7.80 ± 0.41 |
| | SMC | 1.62 ± 0.29 | 6.90 ± 0.18 | 7.42 ± 0.20 | 7.81 ± 0.04 |
| Bc | TAC | 3.57 ± 0.25 | 1.14 ± 0.21 | 2.31 ± 0.63 | 2.30 ± 0.30 |
| | SMC | 2.91 ± 0.06 | 0.92 ± 0.28 | 1.63 ± 0.54 | 2.31 ± 0.93 |
| Sc | TAC | 3.70 ± 0.07 | 7.62 ± 0.20 | 6.95 ± 0.21 | 6.11 ± 0.84 |
| | SMC | 2.72 ± 0.02 | 6.56 ± 0.19 | 7.02 ± 0.28 | 7.49 ± 0.04 |
| Cs | SMC | 3.36 ± 0.21 | 3.57 ± 0.20 | 3.72 ± 0.16 | 3.24 ± 0.51 |
| Pen | SMC | 3.63 ± 0.05 | 2.59 ± 0.04 | 1.36 ± 0.67 | 1.71 ± 0.59 |

TABLE 1C
GVS Samples Stored at 25 degrees Celsius.

| | | Enumerated Organisms (log(CFU/g) or # positive/# tested) | | | |
|---|---|---|---|---|---|
| | | Day 0 | Day 1 | Day 7 | Day 14 |
| Ec | TAC | 3.21 ± 0.21 | 2.32 ± 0.03 | 2.13 ± 0.11 | 1.89 ± 0.17 |
| | SMC | 1.89 ± 0.15 | 2.32 ± 0.01 | 2.23 ± 0.07 | 1.84 ± 0.10 |
| Salm | TAC | 3.41 ± 0.20 | 2.81 ± 0.05 | 4.68 ± 0.08 | 3.84 ± 0.11 |
| | SMC | 3.94 ± 0.04 | 4.48 ± 0.20 | 4.15 ± 0.14 | 3.30 ± 0.22 |
| Li | TAC | 3.58 ± 0.05 | 1.08 ± 0.42 | 1.72 ± 0.19 | 2.74 ± 0.13 |
| | SMC | 3.05 ± 0.22 | 0.88 ± 0.34 | 3/3 | 0/3 |
| Sa | TAC | 3.60 ± 0.06 | 3.31 ± 0.04 | 2.51 ± 0.33 | 1.72 ± 0.39 |
| | SMC | 3.16 ± 0.08 | 3.18 ± 0.04 | 2.53 ± 0.18 | 1.85 ± 0.53 |
| Lacto | TAC | 2.09 ± 0.03 | 3.61 ± 0.14 | 7.29 ± 0.37 | 7.49 ± 0.07 |
| | SMC | 1.62 ± 0.29 | 2.89 ± 0.06 | 7.76 ± 0.04 | 7.50 ± 0.07 |
| Bc | TAC | 3.57 ± 0.25 | 3.39 ± 0.09 | 1.18 ± 0.48 | 2.69 ± 0.15 |
| | SMC | 2.91 ± 0.06 | 3.82 ± 0.09 | 0.96 ± 0.32 | 2.33 ± 0.06 |
| Sc | TAC | 3.70 ± 0.07 | 3.51 ± 0.05 | 7.66 ± 0.09 | 7.02 ± 0.28 |
| | SMC | 2.72 ± 0.02 | 4.68 ± 0.03 | 7.46 ± 0.07 | 6.98 ± 0.27 |
| Cs | SMC | 3.36 ± 0.21 | 3.45 ± 0.38 | 3.22 ± 0.20 | 3.72 ± 0.16 |
| Pen | SMC | 3.63 ± 0.05 | 2.78 ± 0.05 | 6.82 ± 0.06 | 1.66 ± 0.11 |

In GVS samples stored at 4 degrees Celsius, Listeria, mold, and Staphylococcus progressively decreased in numbers over the 90-day storage period. By contrast, E. coli, Bacillus, and Clostridium persisted, and yeast and Lactobacillus increased in number during the storage period. These trends in microbial growth were similar when the plates were incubated at temperatures ranging from about 10° C. to 25° C. although the overall activity (i.e., the rate of increase or decrease) of microbes was reduced at lower storage temperatures.

TABLE 2A
GBP Samples Stored at 4 degrees Celsius.

| | | Enumerated Organisms (log(CFU/g) or # positive/# tested) | | | |
|---|---|---|---|---|---|
| | | Day 0 | Day 28 | Day 60 | Day 90 |
| Ec | TAC | 3.32 ± 0.01 | 3.45 ± 0.24 | 2.20 ± 0.74 | 2.47 ± 0.32 |
| | SMC | 1.76 ± 0.22 | 1.74 ± 0.33 | 1.85 ± 0.18 | 1.66 ± 0.42 |
| Salm | TAC | 3.66 ± 0.05 | 3.72 ± 0.60 | 3.85 ± 0.50 | 3.20 ± 0.31 |
| | SMC | 3.46 ± 0.11 | 4.42 ± 0.79 | 1.92 ± 1.22 | 2.61 ± 1.74 |
| Li | TAC | 2.59 ± 0.11 | 1.78 ± 0.80 | 0.90 ± 0.30 | 2.18 ± 0.26 |
| | SMC | 1.55 ± 0.17 | 0/3 | 0/3 | 0/3 |
| Sa | TAC | 3.58 ± 0.04 | 3.68 ± 0.82 | 3.07 ± 0.41 | 3.02 ± 0.39 |
| | SMC | 3.11 ± 0.08 | 1.66 ± 0.86 | 1/3 | 0/3 |
| Lacto | TAC | 3.27 ± 0.42 | 4.30 ± 0.25 | 7.42 ± 0.26 | 6.36 ± 0.16 |
| | SMC | 2.38 ± 0.71 | 4.32 ± 0.29 | 7.53 ± 0.11 | 6.43 ± 0.10 |
| Bc | TAC | 1.97 ± 0.05 | 2.30 ± 0.30 | 0.90 ± 0.03 | 3.69 ± 0.19 |
| | SMC | 1.40 ± 0.07 | 1.65 ± 0.06 | 0.73 ± 0.51 | 3.80 ± 0.08 |
| Sc | TAC | 3.12 ± 0.07 | ND | ND | 5.23 ± 0.25 |
| | SMC | 2.79 ± 0.06 | 5.51 ± 0.15 | 6.12 ± 0.75 | 6.34 ± 0.36 |
| Cs | SMC | 3.09 ± 0.41 | 3.18 ± 0.62 | 3.06 ± 0.24 | 3.40 ± 0.27 |
| Pen | SMC | 3.70 ± 0.02 | 2.61 ± 0.07 | 2.51 ± 0.22 | 1.01 ± 0.85 |

TABLE 2B
GBP Samples Stored at 10 degrees Celsius.

| | | Enumerated Organisms (log(CFU/g) or # positive/# tested) | | | |
|---|---|---|---|---|---|
| | | Day 0 | Day 7 | Day 14 | Day 28 |
| Ec | TAC | 3.32 ± 0.01 | 0.94 ± 0.60 | 1.85 ± 0.19 | 3.53 ± 0.65 |
| | SMC | 1.76 ± 0.22 | 2.29 ± 0.12 | 2.10 ± 0.23 | 1.88 ± 0.21 |
| Salm | TAC | 3.66 ± 0.05 | 4.74 ± 0.07 | 4.55 ± 0.05 | 4.59 ± 0.42 |
| | SMC | 3.46 ± 0.11 | 4.38 ± 0.12 | 4.51 ± 0.14 | 4.46 ± 0.08 |
| Li | TAC | 2.59 ± 0.11 | 0.93 ± 0.59 | 0.98 ± 0.37 | 2.30 ± 0.10 |
| | SMC | 1.55 ± 0.17 | 0.40 ± 0.17 | 0.92 ± 0.28 | 0/3 |
| Sa | TAC | 3.58 ± 0.04 | 3.62 ± 0.13 | 4.12 ± 0.16 | ND |
| | SMC | 3.11 ± 0.08 | 2.71 ± 0.13 | 2.62 ± 0.11 | 1.11 ± 1.16 |
| Lacto | TAC | 3.27 ± 0.42 | 5.06 ± 0.17 | 5.73 ± 0.10 | 7.82 ± 0.62 |
| | SMC | 2.38 ± 0.71 | 5.08 ± 0.18 | 6.20 ± 0.20 | 6.65 ± 1.86 |
| Bc | TAC | 1.97 ± 0.05 | 1.71 ± 0.19 | 1.04 ± 0.45 | 2.30 ± 0.03 |
| | SMC | 1.40 ± 0.07 | 0.90 ± 0.30 | 1.12 ± 0.07 | 1.61 ± 0.17 |
| Sc | TAC | 3.12 ± 0.07 | 5.23 ± 0.25 | 5.23 ± 0.25 | 3.00 ± 0.84 |
| | SMC | 2.79 ± 0.06 | 6.52 ± 0.12 | 6.28 ± 0.13 | 7.45 ± 0.32 |
| Cs | SMC | 3.09 ± 0.41 | 3.58 ± 0.07 | 3.54 ± 0.13 | 3.84 ± 0.25 |
| Pen | SMC | 3.70 ± 0.02 | 2.64 ± 0.16 | 2.65 ± 0.10 | 2.60 ± 0.10 |

TABLE 2C
GBP Samples Stored at 25 degrees Celsius.

| | | Enumerated Organisms (log(CFU/g) or # positive/# tested) | | | |
|---|---|---|---|---|---|
| | | Day 0 | Day 1 | Day 7 | Day 14 |
| Ec | TAC | 3.32 ± 0.01 | 2.36 ± 0.04 | 2.32 ± 0.11 | 6.72 ± 0.07 |
| | SMC | 1.76 ± 0.22 | 2.30 ± 0.03 | 1.97 ± 0.17 | 0.68 ± 0.66 |
| Salm | TAC | 3.66 ± 0.05 | 4.27 ± 0.21 | 4.28 ± 0.14 | 4.31 ± 0.11 |
| | SMC | 3.46 ± 0.11 | 4.41 ± 0.12 | 4.27 ± 0.21 | 4.20 ± 0.11 |
| Li | TAC | 2.59 ± 0.11 | 1.62 ± 0.28 | 1.94 ± 0.24 | 3.15 ± 0.21 |
| | SMC | 1.55 ± 0.17 | 0.78 ± 0.44 | 3/3 | 0/3 |
| Sa | TAC | 3.58 ± 0.04 | 3.13 ± 0.11 | 2.86 ± 0.16 | 1.72 ± 0.39 |
| | SMC | 3.11 ± 0.08 | 3.11 ± 0.01 | 1.85 ± 0.52 | 1.85 ± 0.53 |
| Lacto | TAC | 3.27 ± 0.42 | 3.70 ± 0.02 | 7.26 ± 0.16 | 7.85 ± 0.12 |
| | SMC | 2.38 ± 0.71 | 1.98 ± 0.37 | 7.37 ± 0.05 | 6.98 ± 0.71 |
| Bc | TAC | 1.97 ± 0.05 | 3.51 ± 0.21 | 1.72 ± 0.17 | 1.34 ± 0.49 |
| | SMC | 1.40 ± 0.07 | 4.04 ± 0.11 | 0.86 ± 0.24 | 1.61 ± 0.68 |
| Sc | TAC | 3.12 ± 0.07 | 3.72 ± 0.03 | 5.23 ± 0.25 | 7.18 ± 0.51 |
| | SMC | 2.79 ± 0.06 | 4.70 ± 0.03 | 7.50 ± 0.09 | 7.86 ± 0.02 |
| Cs | SMC | 3.09 ± 0.41 | 3.22 ± 0.12 | 3.58 ± 0.07 | 2.95 ± 0.23 |
| Pen | SMC | 3.70 ± 0.02 | 2.84 ± 0.13 | 1.74 ± 0.09 | 2/3 |

Growth of test organisms introduced into GBP samples was assessed. Counts of E. coli, Listeria, mold and Staphylococcus decreased. Salmonella exhibited limited growth and persisted through the storage period at 25 degrees Celsius. Bacillus and Clostridia levels remained constant throughout storage, suggesting that spores of neither organism germinated during storage. Both Lactobacillus and yeast grew in the GBP samples during storage at 25 degrees Celsius, increasing roughly 10,000-fold over inoculated levels.

For samples maintained at 10 degrees Celsius, E. coli, Staphylococcus, Bacillus and Clostridia test organisms persisted in GBP samples during the storage period and Salmonella exhibited limited growth and persisted during storage. Listeria levels declined, although at a slower rate of decrease than for samples stored at 25 degrees Celsius. Yeasts and Lactobacillus increased in number in the GBP samples incubated at 10 degrees Celsius, although at a slower rate of increase than in samples incubated at 25 degrees Celsius.

The results of the experiments presented in this Example demonstrate that the VFCOs studied in those experiments are able to persist in botanical foodstuff samples under the storage conditions studied. Those results suggest that it is desirable (or necessary, from a health and sanitation standpoint) to inactivate VFCOs that may be introduced (e.g., during processing) into packaged botanical foodstuffs.

### Example 2

Effect of Chamber Pressure on the Efficacy of HPP Treatment

In the experiments described in this example, GSV and GBP samples were inoculated with test organisms, treated with an HPP process, stored, and test organisms were enumerated in the stored, HPP-treated samples in order to determine the effect of HPP treatment on pathogen counts.

GBP and GVS samples were prepared, divided into approximately 100 gram aliquots, acidified to approximately pH 4.5, and sealed into pouches. Control samples and triplicate acidified samples were inoculated with individual pathogens or spoilage organisms at a density of approximately 10,000,000 CFU per pouch. The pathogens included Clostridium sporogenes, E. coli 0157:H7, Listeria inocua, Salmonella species and Staphylococcus aureus and the spoilage organisms included Bacillus coagulans, a Lactobacillus plantarum and Lactobacillus brevis cocktail, Saccharomyces cerevisiae, and mold (Penicillium sp.).

Individual pouches were processed using HPP at one of two process pressures of approximately 500 MPa and 650 MPa, and for one of three process times ranging from two to four minutes. Following HPP treatment, samples were taken and the remaining pouches were incubated at approximately 4 degrees Celsius for time intervals ranging from 0 to 60 days. Microbiological analysis was performed on the samples upon sampling. The results appear in the following tables (Tables 3A, 3B, and 3C for GVS samples treated at 540 MPa for 120, 180, and 240 seconds, respectively; Tables 4A, 4B, and 4C for GVS samples treated at 600 MPa for 120, 180, and 240 seconds, respectively; Tables 5A, 5B, and 5C for GBP samples treated at 540 MPa for 120, 180, and 240 seconds, respectively; Tables 6A, 6B, and 6C for GBP samples treated at 600 MPa for 120, 180, and 240 seconds, respectively).

TABLE 3A
GVS Samples HPP-treated at 540 MPa for 120 seconds.

| | Enumerated Organisms (log(CFU/g) | | |
|---|---|---|---|
| | or # positive/# tested) | | |
| | Day 0 | Day 26 | Day 60 |
| E. coli | 2.66 ± 0.39 | 1.91 ± 0.19 | 0/3 |
| Salmonella | ND | 0/3 | 0/3 |
| L. innocua | ND | 0/3 | 0/3 |
| S. aureus | 1.75 ± 0.12 | 1.40 ± 0.18 | 1/3 |
| Lactobacillus | ND | 1.92 ± 1.45 | 2.64 ± 1.15 |
| B. coagulans | 5.77 ± 0.05 | 6.29 ± 0.05 | 5.54 ± 0.04 |
| S. cerevisiae | ND | 3/3 | 2.38 ± 1.16 |
| C. sporogenes | 5.46 ± 0.14 | 3.33 ± 0.01 | 3.86 ± 0.05 |
| Penicillium | 5.53 ± 1.68 | 0/3 | 1.04 ± 0.77 |

TABLE 3B
GVS Samples HPP-treated at 540 MPa for 180 seconds.

| | Enumerated Organisms (log(CFU/g) | | |
|---|---|---|---|
| | or # positive/# tested) | | |
| | Day 0 | Day 26 | Day 60 |
| E. coli | 0.3 | 2.68 ± 0.67 | 0/3 |
| Salmonella | ND | 0/3 | 0/3 |
| L. innocua | ND | 0/3 | 0/3 |
| S. aureus | 1.70 ± 0.09 | 1.40 ± 0.15 | 0/3 |
| Lactobacillus | ND | 0.51 ± 0.88 | 2.94 ± 0.96 |
| B. coagulans | 5.68 ± 0.09 | 6.06 ± 0.06 | 5.53 ± 0.04 |
| S. cerevisiae | 2.30 | 3/3 | 1.88 ± 0.77 |
| C. sporogenes | 5.18 ± 0.54 | 3.31 ± 0.00 | 3.32 ± 0.22 |
| Penicillium | ND | 0.16 ± 0.28 | 0.10 ± 0.17 |

TABLE 3C
GVS Samples HPP-treated at 540 MPa for 240 seconds.

| | Enumerated Organisms (log(CFU/g) | | |
|---|---|---|---|
| | or # positive/# tested) | | |
| | Day 0 | Day 26 | Day 60 |
| E. coli | ND | 2.36 ± 0.42 | 0/3 |
| Salmonella | ND | 0/3 | 0/3 |
| L. innocua | ND | 0/3 | 0/3 |
| S. aureus | 1.80 ± 0.17 | 0.77 ± 0.70 | 0/3 |
| Lactobacillus | ND | 1/3 | 3.00 ± 0.63 |
| B. coagulans | 5.53 ± 0.07 | 6.02 ± 0.05 | 5.58 ± 0.03 |
| S. cerevisiae | ND | 3/3 | 1.35 ± 0.43 |
| C. sporogenes | 5.55 ± 0.07 | 3.33 ± 0.03 | 3.05 ± 0.07 |
| Penicillium | 5.53 ± 1.68 | 1/3 | 1/3 |

TABLE 4A
GVS Samples HPP-treated at 600 MPa for 120 seconds.

| | Enumerated Organisms (log(CFU/g) | | |
|---|---|---|---|
| | or # positive/# tested) | | |
| | Day 0 | Day 26 | Day 60 |
| E. coli | ND | 2.99 ± 0.88 | 0/3 |
| Salmonella | ND | 0/3 | 0/3 |
| L. innocua | ND | 0/3 | 0/3 |
| S. aureus | 1.51 ± 0.19 | 1.30 ± 0.22 | 0/3 |
| Lactobacillus | 2.30 | 0/3 | 2.96 ± 0.84 |
| B. coagulans | 5.51 ± 0.17 | 6.04 ± 0.04 | 5.55 ± 0.04 |
| S. cerevisiae | 2.30 | 3/3 | 2.52 ± 1.02 |
| C. sporogenes | 5.62 ± 0.13 | 3.34 ± 0.02 | 3.64 ± 0.26 |
| Penicillium | ND | 1/3 | 0.67 ± 0.64 |

TABLE 4B
GVS Samples HPP-treated at 600 MPa for 180 seconds.

| | Enumerated Organisms (log(CFU/g) | | |
|---|---|---|---|
| | or # positive/# tested) | | |
| | Day 0 | Day 26 | Day 60 |
| E. coli | ND | 2.67 ± 0.30 | 0/3 |
| Salmonella | ND | 0/3 | 0/3 |
| L. innocua | ND | 0/3 | 0/3 |
| S. aureus | 1.44 ± 0.15 | 0.38 ± 0.66 | 0/3 |
| Lactobacillus | 2.30 | 1/3 | 3.52 ± 0.59 |
| B. coagulans | 5.67 ± 0.07 | 6.09 ± 0.09 | 5.54 ± 0.07 |
| S. cerevisiae | 1/3 | 3/3 | 2.18 ± 0.60 |
| C. sporogenes | 5.17 ± 0.30 | 3.34 ± 0.03 | 3.65 ± 0.71 |
| Penicillium | ND | 2/3 | 0.85 ± 0.94 |

TABLE 4C
GVS Samples HPP-treated at 600 MPa for 240 seconds.

| | Enumerated Organisms (log(CFU/g) | | |
|---|---|---|---|
| | or # positive/# tested) | | |
| | Day 0 | Day 26 | Day 60 |
| E. coli | ND | 3.15 ± 0.33 | 0/3 |
| Salmonella | ND | 0/3 | 0/3 |
| L. innocua | ND | 0/3 | 0/3 |
| S. aureus | 1.50 ± 0.30 | 0.73 ± 0.63 | 0/3 |
| Lactobacillus | ND | 1/3 | 2.10 ± 0.46 |
| B. coagulans | 5.63 ± 0.08 | 6.01 ± 0.06 | 5.53 ± 0.02 |
| S. cerevisiae | 1/3 | 3/3 | 0.50 ± 0.17 |
| C. sporogenes | 4.86 ± 0.30 | 3.34 ± 0.02 | 3.82 ± 0.22 |
| Penicillium | ND | 0/3 | 1.55 ± 0.31 |

TABLE 5A
GBP Samples HPP-treated at 540 MPa for 120 seconds.

| | Enumerated Organisms (log(CFU/g) | | |
|---|---|---|---|
| | or # positive/# tested) | | |
| | Day 0 | Day 26 | Day 60 |
| E. coli | 2.35 ± 0.07 | 2.77 ± 0.39 | 0/3 |
| Salmonella | ND | 0/3 | 0/3 |
| L. innocua | 0.26 | 0.59 ± 0.11 | 0/3 |
| S. aureus | 1.75 ± 0.12 | 0.46 ± .41 | 0.20 ± 0.17 |
| Lactobacillus | ND | 0/3 | 2.09 ± 0.73 |
| B. coagulans | 5.84 ± 0.22 | 6.17 ± 0.08 | 6.01 ± 0.05 |
| S. cerevisiae | ND | 3/3 | 0.40 ± 0.17 |
| C. sporogenes | 4.99 ± 0.21 | 3.32 ± 0.01 | 2.98 ± 0.35 |
| Penicillium | ND | 0/3 | 1.71 ± 0.20 |

TABLE 5B
GBP Samples HPP-treated at 540 MPa for 180 seconds.

| | Enumerated Organisms (log(CFU/g) | | |
|---|---|---|---|
| | or # positive/# tested) | | |
| | Day 0 | Day 26 | Day 60 |
| E. coli | 1.08 ± 0.23 | 2.04 ± 0.07 | 0/3 |
| Salmonella | ND | 0/3 | 0/3 |
| L. innocua | ND | 0.10 ± 0.17 | ND |
| S. aureus | 1.70 ± 0.09 | 0.67 ± 0.06 | 0.20 ± 0.17 |
| Lactobacillus | 0.45 ± 0.15 | 0.65 ± 0.61 | 2.18 ± 0.42 |
| B. coagulans | 5.79 ± 0.25 | 6.11 ± 0.26 | 5.98 ± 0.06 |
| S. cerevisiae | ND | 3/3 | 0.66 ± 0.32 |
| C. sporogenes | 5.02 ± 0.12 | 3.31 ± 0.00 | 3.66 ± 0.24 |
| Penicillium | 0.90 | 0/3 | 0.87 ± 0.56 |

TABLE 5C
GBP Samples HPP-treated at 540 MPa for 240 seconds.

| | Enumerated Organisms (log(CFU/g) | | |
|---|---|---|---|
| | or # positive/# tested) | | |
| | Day 0 | Day 26 | Day 60 |
| E. coli | 1.64 ± 0.83 | 3.14 ± 0.20 | 0/3 |
| Salmonella | ND | 0/3 | 0/3 |
| L. innocua | ND | 0.36 ± 0.62 | 0/3 |
| S. aureus | 1.50 ± 0.17 | 0.20 ± 0.17 | 0.56 ± 0.24 |
| Lactobacillus | 2.3 | 0/3 | 2.47 ± 0.12 |
| B. coagulans | 5.75 ± 0.12 | 6.36 ± 0.10 | 6.02 ± 0.06 |
| S. cerevisiae | ND | 0.79 ± 0.90 | 1.17 ± 0.34 |
| C. sporogenes | 4.77 ± 0.16 | 3.34 ± 0.01 | 3.64 ± 0.04 |
| Penicillium | 0.90 | 0/3 | 2.63 ± 0.99 |

TABLE 6A
GBP Samples HPP-treated at 600 MPa for 120 seconds.

| | Enumerated Organisms (log(CFU/g) | | |
|---|---|---|---|
| | or # positive/# tested) | | |
| | Day 0 | Day 26 | Day 60 |
| E. coli | 1.84 ± 0.26 | 3.24 ± 0.22 | 0/3 |
| Salmonella | ND | 0/3 | 0/3 |
| L. innocua | ND | 0.95 ± 0.37 | 0/3 |
| S. aureus | 1.51 ± 0.19 | 0.10 ± 0.17 | 0.20 ± 0.17 |
| Lactobacillus | 2.3 | 0/3 | 1.83 ± 0.29 |
| B. coagulans | 5.78 ± 0.09 | 6.33 ± 0.03 | 5.97 ± 0.11 |
| S. cerevisiae | ND | 2/3 | 1.51 ± 0.24 |
| C. sporogenes | 5.01 ± 0.16 | 3.34 ± 0.02 | 2.98 ± 0.62 |
| Penicillium | ND | 0/3 | 1.35 ± 0.58 |

TABLE 6B
GBP Samples HPP-treated at 600 MPa for 180 seconds.

| | Enumerated Organisms (log(CFU/g) | | |
|---|---|---|---|
| | or # positive/# tested) | | |
| | Day 0 | Day 26 | Day 60 |
| E. coli | 2.29 ± 0.20 | 1.87 ± 0.39 | 0/3 |
| Salmonella | ND | 0/3 | 0/3 |
| L. innocua | 2.30 | 2/3 | 0/3 |
| S. aureus | 1.44 ± 0.15 | 0.10 ± 0.17 | 0/3 |
| Lactobacillus | ND | 0/3 | 2.03 ± 0.53 |
| B. coagulans | 5.77 ± 0.12 | 6.38 ± 0.10 | 5.94 ± 0.06 |
| S. cerevisiae | ND | 3/3 | 1.15 ± 0.26 |
| C. sporogenes | 5.19 ± 0.28 | 3.32 ± 0.01 | 3.26 ± 0.14 |
| Penicillium | ND | 0/3 | 1.23 ± 0.56 |

TABLE 6C
GBP Samples HPP-treated at 600 MPa for 240 seconds.

| | Enumerated Organisms (log(CFU/g) | | |
|---|---|---|---|
| | or # positive/# tested) | | |
| | Day 0 | Day 26 | Day 60 |
| E. coli | 2.20 ± 0.41 | 2.95 ± 0.21 | 0/3 |
| Salmonella | ND | 0/3 | 0/3 |
| L. innocua | ND | 2/3 | 0/3 |
| S. aureus | 1.50 ± 0.30 | 0.10 ± 0.17 | 0.85 ± 0.13 |
| Lactobacillus | 2.30 | 0/3 | 1.12 ± 0.04 |
| B. coagulans | 5.82 ± 0.10 | 6.36 ± 0.15 | 5.54 ± 0.06 |
| S. cerevisiae | ND | 2/3 | 0.50 ± 0.35 |
| C. sporogenes | 5.07 ± 0.42 | 3.33 ± 0.02 | 2.25 ± 0.03 |
| Penicillium | ND | 0/3 | 1.01 ± 0.56 |

As illustrated in the table above, application of the HPP at controlled low (ca. 4.5) pH reduced levels of Lactobacillus, molds, and yeast introduced into GVS and GBP samples with negligible recovery during post-treatment storage. Of the pathogens, E. coli increased in both products over the initial 26 day storage period but declined thereafter. Little or no evidence of post-HPP treatment growth of Listeria or Salmonella was observed in either vegetable product at either process pressure and their levels decreased progressively over the storage period. Staphylococcus aureus levels also declined during storage, although low residual populations persisted in the GBP product. There was little to no change in the levels of Bacillus or Clostridia in either sample type during the storage period.

The results of the experiments described in this Example indicate that the efficacy of HPP to achieve microbial reduction can be enhanced by increasing the duration of HPP treatment for at least some VFCOs. The duration of HPP treatment appeared to have relatively little effect on survival of spore-forming organisms B. coagulans and C. sporogenes. The difference in VFCO-inactivation achieved at HPP operating pressures of 540 and 600 MPa appears not to be significant for the VFCOs tested.

### Example 3

Effect of pH on Efficacy of HPP Treatment

The experiments presented in this Example were performed to study the effect of pH on the efficacy of HPP to inactivate model pathogens and spoilage organisms inoculated into botanical foodstuff samples. GVS and GBP samples were prepared in bulk, adjusted to pH 4.3, 4.4 or 4.5, packaged into pouches in 100 gram aliquots, and inoculated individually with one of the pathogens or spoilage organisms. Individual pouches were inoculated with the appropriate microbe to a final cell density of approximately 10,000,000 CFU per pouch of one of Salmonella, Listeria innocua and Escherichia coli 0157:H7 stx⁻, or Lactobacillus (Lactobacillus plantarum and brevis cocktail) and to a final cell density of approximately 10,000 CFU per pouch for Saccharomyces cerevisiae. The pouches were sealed, and one set was removed to determine initial counts. The remaining samples were subjected to HPP treatment for a duration of 1 to 10 minutes at about 600 MPa with subsequent enumeration of organisms.

Following HPP treatment, the pouches were opened, neutralized, homogenized and dilution series were prepared in saline. The homogenate and/or dilutions were plated onto media plates and incubated prior to enumeration. In the event that no colonies were detected on the plates, the samples were enriched prior to plating as described herein.

The following tables tabulate initial counts and log count reductions (one “log count reduction” is a ten-fold reduction in number) of the test organisms introduced into GVS samples adjusted to different pH values.

TABLE 7A
E. coli Survival in HPP-treated GVS Samples.

| | | |
|---|---|---|
| Minutes of HPP | | |
| Treatment | pH 4.3 | pH 4.4 |

Pre-Treatment Enumeration
(log(CFU/pouch))

| | | |
|---|---|---|
| 0.0 | 6.98 ± 0.05 | 6.82 ± 0.02 |
| 0.0 | 6.78 ± 0.09 | 6.16 ± 0.63 |

Post-Treatment Reduction in
Enumerated Organisms (log(CFU/pouch)
or # positive/# tested)

| | | |
|---|---|---|
| 1.5 | −6.16 ± 0.62 | |
| 2.0 | −6.58 ± 0.34 | |
| 3.0 | 0/3 | −6.52 ± 0.39 |
| 4.0 | 0/3 | 0/3 |
| 5.0 | 0/3 | 0/3 |
| 6.0 | | 0/3 |
| 7.0 | | 0/3 |

TABLE 7B
Salmonella Survival in HPP-treated GVS Samples.

| | | |
|---|---|---|
| Minutes of HPP | | |
| Treatment | pH 4.3 | pH 4.4 |

Pre-Treatment Enumeration
(log(CFU/pouch))

| | | |
|---|---|---|
| 0.0 | 7.5 ± 0.65 | 7.14 ± 0.40 |
| 0.0 | 7.22 ± 0.08 | 7.22 ± 0.11 |

Post-Treatment Reduction in
Enumerated Organisms (log(CFU/pouch)
or # positive/# tested)

| | | |
|---|---|---|
| 1.5 | 0/3 | |
| 2.0 | 0/3 | 0/3 |
| 3.0 | 0/3 | 0/3 |
| 4.0 | 0/3 | 0/3 |
| 5.0 | 0/3 | 0/3 |
| 6.0 | | 0/3 |
| 7.0 | | 0/3 |

TABLE 7C
L. innocula Survival in HPP-treated GVS Samples.

| | | |
|---|---|---|
| Minutes of HPP | | |
| Treatment | pH 4.3 | pH 4.4 |

Pre-Treatment Enumeration
(log(CFU/pouch))

| | | |
|---|---|---|
| 0.0 | 7.14 ± 0.20 | 7.55 ± 0.04 |
| 0.0 | 7.22 ± 0.07 | 7.43 ± 0.01 |

Post-Treatment Reduction in
Enumerated Organisms (log(CFU/pouch)
or # positive/# tested)

| | | |
|---|---|---|
| 1.5 | | |
| 2.0 | 0/3 | |
| 3.0 | 0/3 | 0/3 |
| 4.0 | 0/3 | 0/3 |
| 5.0 | 0/3 | 0/3 |
| 6.0 | | 0/3 |
| 7.0 | | 0/3 |

TABLE 7D
Lactobacillus Survival in HPP-treated GVS Samples.

| Minutes of HPP | | | |
|---|---|---|---|
| Treatment | pH 4.3 | pH 4.4 | pH 4.5 |
| | Pre-Treatment Enumeration (log(CFU/pouch)) | | |
| 0.0 | 3.04 ± 0.16 | 3.26 ± 0.04 | 3.24 ± 0.38 |
| 0.0 | 3.19 ± 0.06 | 3.12 ± 0.09 | 3.08 ± 0.15 |
| | Post-Treatment Reduction in Enumerated Organisms | | |
| | (log(CFU/pouch) or # positive/# tested) | | |
| 1.5 | −1.24 ± 0.09 | | |
| 2.0 | −2.35 ± 0.21 | | |
| 3.0 | −2.56 ± 0.35 | −2.82 ± 0.00 | |
| 4.0 | −2.89 ± 0.30 | −3.02 ± 0.17 | |
| 5.0 | −3.09 ± 0.17 | −3.02 ± 0.17 | 0/3 |
| 6.0 | | 0/3 | 0/3 |
| 7.0 | | 0/3 | 0/3 |
| 8.0 | | | 0/3 |
| 9.0 | | | 0/3 |

TABLE 7E
S. cerevisiae Survival in HPP-treated GVS Samples.

| Minutes of HPP | | | |
|---|---|---|---|
| Treatment | pH 4.3 | pH 4.4 | pH 4.5 |
| | Pre-Treatment Enumeration (log(CFU/pouch)) | | |
| 0.0 | 4.06 ± 0.04 | 3.98 ± 0.12 | 4.26 ± 0.14 |
| 0.0 | 3.98 ± 0.03 | 4.04 ± 0.07 | 4.01 ± 0.09 |
| | Post-Treatment Reduction in Enumerated Organisms | | |
| | (log(CFU/pouch) or # positive/# tested) | | |
| 1.5 | 0/3 | | |
| 2.0 | 0/3 | | |
| 3.0 | 1/3 | 3/3 | |
| 4.0 | 1/3 | 0/3 | |
| 5.0 | 0/3 | 3/3 | 3/3 |
| 6.0 | | 1/3 | 3/3 |
| 7.0 | | 1/3 | 3/3 |
| 8.0 | | | 3/3 |
| 9.0 | | | 3/3 |

The following tables tabulate initial organism counts and reductions of the test organisms introduced into GBP samples adjusted to different pH values.

TABLE 8A
E. coli Survival in HPP-treated GBP Samples.

| Minutes of HPP | | | |
|---|---|---|---|
| Treatment | pH 4.3 | pH 4.4 | pH 4.5 |
| | Pre-Treatment Enumeration (log(CFU/pouch)) | | |
| 0.0 | 6.99 ± 0.68 | 6.82 ± 0.28 | 7.02 ± 0.32 |
| 0.0 | 6.90 ± 0.04 | 6.83 ± 0.11 | 6.91 ± 0.20 |
| | Post-Treatment Reduction in Enumerated Organisms | | |
| | (log(CFU/pouch) or # positive/# tested) | | |
| 1.5 | −4.53 ± 0.41 | | |
| 2.0 | −5.99 ± 0.39 | | |
| 3.0 | −5.26 ± 0.42 | 0/3 | |
| 4.0 | −5.79 ± 0.82 | 0/3 | |
| 5.0 | −6.70 ± 0.35 | 0/3 | 0/3 |
| 6.0 | | 0/3 | 0/3 |
| 7.0 | | 0/3 | 0/3 |
| 8.0 | | | 0/3 |
| 9.0 | | | 0/3 |

TABLE 8B
Salmonella Survival in HPP-treated GBP Samples.

| | | |
|---|---|---|
| Minutes of HPP | | |
| Treatment | pH 4.3 | pH 4.4 |

Pre-Treatment Enumeration
(log(CFU/pouch))

| | | |
|---|---|---|
| 0.0 | 7.04 ± 0.20 | 7.12 ± 0.62 |
| 0.0 | 7.00 ± 0.20 | 6.98 ± 0.06 |

Post-Treatment Reduction in
Enumerated Organisms (log(CFU/pouch)
or # positive/# tested)

| | | |
|---|---|---|
| 1.5 | 0/3 | |
| 2.0 | 0/3 | |
| 3.0 | 0/3 | 0/3 |
| 4.0 | 0/3 | 0/3 |
| 5.0 | 0/3 | 0/3 |
| 6.0 | | 0/3 |
| 7.0 | | 0/3 |

TABLE 8C
L. inocula Survival in HPP-treated GBP Samples.

| Minutes of HPP | | | |
|---|---|---|---|
| Treatment | pH 4.3 | pH 4.4 | pH 4.5 |
| | Pre-Treatment Enumeration (log(CFU/pouch)) | | |
| 0.0 | 6.57 ± 0.10 | 6.83 ± 0.60 | |
| 0.0 | 5.60 ± 0.05 | 5.69 ± 0.19 | |
| | Post-Treatment Reduction in Enumerated Organisms | | |
| | (log(CFU/pouch) or # positive/# tested) | | |
| 1.5 | 0/3 | | |
| 2.0 | 0/3 | | |
| 3.0 | 0/3 | 0/3 | |
| 4.0 | 0/3 | 0/3 | |
| 5.0 | 0/3 | 0/3 | |
| 6.0 | | 0/3 | |
| 7.0 | | 0/3 | |
| 8.0 | | | |
| 9.0 | | | |

TABLE 8D
Lactobacillus Survival in HPP-treated GBP Samples.

| Minutes of HPP | | | |
|---|---|---|---|
| Treatment | pH 4.3 | pH 4.4 | pH 4.5 |
| | Pre-Treatment Enumeration (log(CFU/pouch)) | | |
| 0.0 | 3.11 ± 0.08 | 3.23 ± 0.12 | 3.32 ± 0.16 |
| 0.0 | 3.08 ± 0.13 | 3.16 ± 0.10 | 3.12 ± 0.06 |
| | Post-Treatment Reduction in Enumerated Organisms | | |
| | (log(CFU/pouch) or # positive/# tested) | | |
| 1.5 | −2.26 ± 0.24 | | |
| 2.0 | −2.82 ± 0.45 | | |
| 3.0 | −2.62 ± 0.28 | −3.06 ± 0.17 | |
| 4.0 | −2.88 ± 0.17 | −2.96 ± 0.17 | |
| 5.0 | 0/3 | 0/3 | −2.92 ± 0.35 |
| 6.0 | | −2.60 ± 0.49 | 3/3 |
| 7.0 | | −2.70 ± 0.41 | 0/3 |
| 8.0 | | | 2/3 |
| 9.0 | | | 2/3 |

TABLE 8E
S. cerevisiae Survival in HPP-treated GBP Samples.

| Minutes of HPP | | | |
|---|---|---|---|
| Treatment | pH 4.3 | pH 4.4 | pH 4.5 |
| | Pre-Treatment Enumeration (log(CFU/pouch)) | | |
| 0.0 | 3.54 ± 0.36 | 3.87 ± 0.32 | 3.99 ± 0.20 |
| 0.0 | 3.98 ± 0.13 | 4.10 ± 0.16 | 3.46 ± 1.26 |
| | Post-Treatment Reduction in Enumerated Organisms | | |
| | (log(CFU/pouch) or # positive/# tested) | | |
| 1.5 | 2/3 | | |
| 2.0 | 0/3 | | |
| 3.0 | 1/3 | 2/3 | |
| 4.0 | 0/3 | 1/3 | |
| 5.0 | 1/3 | 0/3 | 3/3 |
| 6.0 | | 0/3 | 3/3 |
| 7.0 | | −3.20 ± 0.21 | 3/3 |
| 8.0 | | | 3/3 |
| 9.0 | | | 3/3 |

The results presented in this Example demonstrate that HPP treatment resulted in greater than 100,000-fold reduction in E. coli CFU counts in both sample products under all treatment conditions, and that increased acidity enhanced the efficacy of HPP treatment to reduce E. coli levels in the GVS samples but enhance HPP tolerance of the E. Coli bacterium in the GBP sample. All treatment conditions as applied resulted in greater than 100,000-fold reduction in Salmonella and Listeria CFU counts. Lactobacillus, a spoilage organism, demonstrated tolerance to pressure with increased acidity in both vegetable products, which suggests that greater inactivation of spoilage microorganisms by HPP treatment can be achieved at less acidic pH values. A greater level of yeast inactivation by HPP was achieved with higher acidity.

The results described indicate that HPP treatment can reduce counts of pathogenic and spoilage organisms in vegetables and vegetable-containing foodstuffs. The results also suggest that supplementation of HPP treatment with other antimicrobial treatment can further suppress survival and growth of pathogens and spoilage organisms in vegetable containing products.

### Example 4

Synergistic HPP Treatment and Inclusion of a Microbistat

The purposes of the studies described in this example included evaluating the efficacy of HPP treatment alone and the efficacy of HPP treatment combined with supplementation with a fermentate microbistat (a fermented sugar preparations known to contain, in addition to organic acids, one or more bacteriocins, one or more antimycotics, or a combination of these) to reduce the load of viable food-contaminating organisms (FCOs) spiked into packaged botanical foodstuff samples.

The studies in this example were performed as follows. Pouched GVS and GBP samples (ca. 100 grams per sample) were prepared and spiked with test organisms (approximately 10⁵ CFU/g of Lactobacillus, 10⁵ CFU/g of S. cerevisiae, or 10⁵ CFU/g of both of those) prior to pouch sealing. Selected inoculated pouches were HPP treated, and the rest were not. After sealing the inoculated pouches and, if applicable, subjecting them to HPP treatment, the pouches were stored under refrigerated (38 degrees Fahrenheit, equivalent to about 3 degrees Celsius) conditions for up to 150 days. After selected periods (0, 30, 60, 90, and 150 days after inoculation), test organisms were enumerated in samples, generally by assessing samples in triplicate.

The results of the studies in this Example are shown in Tables 9A-10C.

TABLE 9A
Enumeration of Lactobacillus in GVS Samples Spiked with Lactobacillus

| | | Enumerated Organisms | | | | |
|---|---|---|---|---|---|---|
| | | (Average log(CFU/pouch)) on the | | | | |
| | | indicated day of post-inoculation storage | | | | |
| Fermentate | HPP- | | | | Day | Day |
| Microbistat | Treated? | Day 0 | Day 30 | Day 60 | 90 | 150 |
| None | No | 8.68 | 8.91 | 8.46 | 8.43 | 8.38 |
| None | Yes | <3.37 | 2.22 | 2.75 | 2.70 | 0.30 |
| VERDAD RV75 | No | 8.46 | 8.12 | 8.26 | 8.21 | 8.23* |
| VERDAD RV75 | Yes | <3.3 | <2.88 | <2.04 | 2.48 | 0.00 |
| MICROGARD | No | 8.66 | 5.61 | 6.49 | 6.76 | 7.88 |
| 730 | | | | | | |
| MICROGARD | Yes | <3 | <3 | <2 | <2 | <0.4 |
| 730 | | | | | | |

In Tables 9A and 9C, the symbol “*” is used to indicate samples which exhibited visible bloating on account of intra-pouch gas production.

TABLE 9B
Enumeration of S. cerevisiae in GVS Samples Spiked with S. cerevisiae

| | | Enumerated Organisms | | | | |
|---|---|---|---|---|---|---|
| | | (Average log(CFU/pouch)) on the | | | | |
| | | indicated day of post-inoculation storage | | | | |
| Fermentate | HPP- | | | | | Day |
| Microbistat | Treated? | Day 0 | Day 30 | Day 60 | Day 90 | 150 |
| None | No | 7.99 | 8.10 | 7.61 | 7.56 | 7.39 |
| None | Yes | <3 | <3 | <2 | <2 | <0 |
| FRESH S39 | No | 7.97 | 7.28 | 6.21 | 6.43 | 6.24 |
| FRESH S39 | Yes | <3 | <3 | <2 | <2 | <0 |
| MICROGARD | No | 7.95 | 8.27 | 7.29 | 7.23 | 7.51 |
| 200 | | | | | | |
| MICROGARD | Yes | <3 | <3 | <2 | <2.85 | <0 |
| 200 | | | | | | |

TABLE 9C
Enumeration of Lactobacillus and S. cerevisiae in GVS Samples Spiked
with both Lactobacillus and S. cerevisiae

| | | Enumerated Organisms | | | | |
|---|---|---|---|---|---|---|
| | | (Average log(CFU/pouch)) | | | | |
| | | on the indicated day of post-inoculation storage | | | | |
| Fermentate | HPP- | (Lactobacillus reported above S. cerevisiae) | | | | |
| Microbistat | Treated? | Day 0 | Day 30 | Day 60 | Day 90 | Day 150 |
| None | No | 8.68 | 8.91 | 8.46 | 8.43 | 8.38 |
| | | (Lacto.) | | | | |
| | | 7.99 | 8.10 | 7.61 | 7.56 | 7.39 |
| | | (S. c.) | | | | |
| None | Yes | <3.37 | 2.22 | 2.75 | 2.70 | 0.30 |
| | | <3 | <3 | <2 | <2 | <0 |
| FRESH S39 + VERDAD | No | 8.65 | 8.49 | 8.23 | 8.44 | 8.15* |
| RV75 | | 7.98 | 7.26 | 5.59 | 5.56 | <2 |
| FRESH S39 + VERDAD | Yes | <3 | <3 | <2.07 | 2.65 | <0 |
| RV75 | | <3 | <3 | <2 | <2 | <0 |
| MICROGARD 200 + | No | 8.26 | 8.57 | 7.77 | 7.69 | 8.47 |
| MICROGARD730 | | 7.92 | 7.87 | 7.70 | 7.69 | 8.56 |
| MICROGARD 200 + | Yes | <3 | 4.31 | <2.34 | 3.20 | <2.18 |
| MICROGARD730 | | <3 | <3 | <2 | <2 | <0 |

TABLE 10A
Enumeration of Lactobacillus in GBP Samples Spiked with Lactobacillus

| | | Enumerated Organisms | | | | |
|---|---|---|---|---|---|---|
| | | (Average log(CFU/pouch)) on the | | | | |
| | | indicated day of post-inoculation storage | | | | |
| Fermentate | HPP- | | | | Day | Day |
| Microbistat | Treated? | Day 0 | Day 30 | Day 60 | 90 | 150 |
| None | No | 8.68 | 8.93 | 8.38 | 8.19 | 7.34 |
| None | Yes | <3.37 | 2.22 | <2.3 | <2 | <0 |
| VERDAD RV75 | No | 8.46 | 8.12 | 7.46 | 7.51 | 7.92 |
| VERDAD RV75 | Yes | <3.30 | <2.88 | <2.22 | <2 | 0.30 |
| MICROGARD | No | 8.67 | 6.14 | 6.24 | 6.61 | 7.31 |
| 730 | | | | | | |
| MICROGARD | Yes | <3 | <3 | <2 | <2 | <0 |
| 730 | | | | | | |

TABLE 10B
Enumeration of S. cerevisiae in GBP Samples Spiked with S. cerevisiae

| | | Enumerated Organisms | | | | |
|---|---|---|---|---|---|---|
| | | (Average log(CFU/pouch)) on the | | | | |
| | | indicated day of post-inoculation storage | | | | |
| Fermentate | HPP- | | | | | Day |
| Microbistat | Treated? | Day 0 | Day 30 | Day 60 | Day 90 | 150 |
| None | No | 7.94 | 8.22 | 7.67 | 7.32 | 7.37 |
| None | Yes | <3 | <3 | <2 | <2 | <0 |
| FRESH S39 | No | 7.85 | 7.21 | 6.08 | 6.48 | 5.30 |
| FRESH S39 | Yes | <3 | <3 | <2 | <2 | <0 |
| MICROGARD | No | 8.33 | 8.68 | 7.41 | 7.16 | 7.36 |
| 200 | | | | | | |
| MICROGARD | Yes | <3 | <3 | <2 | <2 | <0 |
| 200 | | | | | | |

TABLE 10C
Enumeration of Lactobacillus and S. cerevisiae in GBP Samples Spiked
with both Lactobacillus and S. cerevisiae

| | | Enumerated Organisms | | | | |
|---|---|---|---|---|---|---|
| | | (Average log(CFU/pouch)) | | | | |
| | | on the indicated day of post-inoculation storage | | | | |
| Fermentate | HPP- | (Lactobacillus reported above S. cerevisiae) | | | | |
| Microbistat | Treated? | Day 0 | Day 30 | Day 60 | Day 90 | Day 150 |
| None | No | 8.68 | 8.93 | 8.38 | 8.19 | 7.34 |
| | | (Lacto.) | | | | |
| | | 7.94 | 8.22 | 7.67 | 7.32 | 7.37 |
| | | (S. c.) | | | | |
| None | Yes | <3.37 | 2.22 | <2.3 | <2 | <0 |
| | | <3 | <3 | <2 | <2 | <0 |
| FRESH S39 + VERDAD | No | 8.65 | 8.49 | 7.91 | 8.04 | 7.46 |
| RV75 | | 8.03 | 7.04 | 5.87 | 5.56 | <2 |
| FRESH S39 + VERDAD | Yes | <3 | <3 | <2 | <2 | <0 |
| RV75 | | <3 | <3 | <2 | <2 | <0 |
| MICROGARD 200 + | No | 8.05 | 7.78 | 7.42 | 7.57 | 7.39 |
| MICROGARD730 | | 7.95 | 7.55 | 7.39 | 7.36 | 7.16 |
| MICROGARD 200 + | Yes | <3 | <3 | <2 | <2 | <0 |
| MICROGARD730 | | <3 | <3 | <2 | <2 | <0 |

The results of the studies disclosed in this Example demonstrate that bacteriocins and antimycotic agents, such as those found in the fermentate microbistats disclosed in this Example, can inhibit survival and growth of Lactobacillus and yeast in packaged, HPP-treated botanical foodstuffs. A skilled artisan in this field would also understand that the results of these studies indicate that inclusion of a comestible bacteriocin or a comestible antimycotic (e.g., in the form of a comestible fermentate microbistat) in an HPP-treated botanical foodstuff can inhibit the viability of bacteria and yeasts that may be sublethally injured, but not killed, by the HPP treatment alone, or at least inhibit their revival.

The disclosure of every patent, patent application, and publication cited herein is hereby incorporated herein by reference in its entirety.

While this subject matter has been disclosed with reference to specific embodiments, it is apparent that other embodiments and variations can be devised by others skilled in the art without departing from the true spirit and scope of the subject matter described herein. The appended claims include all such embodiments and equivalent variations.

What is claimed is:

1. A method of packaging a botanical foodstuff for long-term storage, the method comprising
subjecting the foodstuff to a high pressure processing (HPP) treatment sufficient to inactivate at least some viable food-contaminating organisms (VFCOs) in the foodstuff and
aseptically sealing a package containing the foodstuff in fluid communication with a first microbistat in an amount sufficient to inactivate substantially all VFCOs within the package that are not inactivated by the HPP treatment
to yield a packaged, HPP-treated foodstuff that remains comestible after storage at 4 degrees Celsius for one month.

2. The method of claim 1, wherein the package is sealed prior to subjecting the foodstuff to the HPP treatment.

3. The method of claim 1, wherein the microbistat is a bacteriostat.

4. The method of claim 1, wherein the microbistat is a bacteriocin.

5. The method of claim 1, wherein the microbistat is an antimycotic agent.

6. The method of claim 1, wherein the microbistat is an acidulant.

7. The method of claim 6, wherein the acidulant is an organic acid.

8. The method of claim 7, wherein the acidulant is selected from the group consisting of acetic, citric, and lactic acids.

9. The method of claim 1, wherein the microbistat is fermentate microbistat.

10. The method of claim 1, further comprising subjecting the foodstuff to at least a first antimicrobial treatment prior to the HPP treatment, wherein the antimicrobial treatment is selected from the group consisting of heating the foodstuff and contacting the foodstuff with a non-comestible antimicrobial agent.

11. The method of claim 10, wherein the first antimicrobial treatment is selected from the group consisting of blanching the foodstuff and retorting the foodstuff.

12. The method of claim 10, wherein the first antimicrobial treatment is contacting the foodstuff with a non-specific antimicrobial sanitizing agent.

13. The method of claim 12, wherein the sanitizing agent is selected from the group consisting of peracetic acid, chlorinated water, and ozonated water.

14. The method of claim 12, further comprising separating at least most of the sanitizing agent from the foodstuff prior to sealing the package.

15. The method of claim 1, wherein the VFCO load of the packaged, HPP-treated foodstuff is reduced at least 100,000-fold relative to the VFCO load of the foodstuff prior to HPP treatment and packaging in fluid communication with the microbistat.

16. The method of claim 15, wherein the reduction is at least 1,000,000-fold.

17. The method of claim 15, wherein the reduction is at least 10,000,000-fold.

18. The method of claim 15, wherein the reduction is at least 100,000,000-fold.

19. The method of claim 1, wherein the package also contains a comestible sauce intended for consumption with the foodstuff.

20. The method of claim 19, wherein the microbistat is disposed in the sauce and the sauce contacts the foodstuff within the package.

21. The method of claim 1, wherein an organoleptic property of the foodstuff remains substantially unchanged after storage of the HPP-treated, packaged foodstuff at 4 degrees Celsius for one month, relative to the same property of the foodstuff prior to HPP treatment and packaging with the microbistat.

22. The method of claim 21, wherein the property is a texture.

23. The method of claim 22, wherein the texture is crispness.

24. The method of claim 21, wherein the property is a flavor.

25. The method of claim 24, wherein the flavor is a flavor characteristic of the vegetable prior to cooking and not a flavor characteristic of the vegetable after cooking.

26. The method of claim 21, wherein the property is a color.

27. The method of claim 26, wherein the color is a color characteristic of the vegetable in a ripened state.

28. The method of claim 26, wherein the color is a color characteristic of the vegetable prior to cooking and not a color characteristic of the vegetable after cooking.

29. The method of claim 1, wherein the packaged, HPP-treated foodstuff remains comestible after storage at 4 degrees Celsius for six months.

30. The method of claim 1, wherein the packaged, HPP-treated foodstuff remains comestible after storage at 4 degrees Celsius for twelve months.

31. A method of reducing the load of viable food-contaminating organisms (VFCOs) in a packaged botanical foodstuff, the method comprising
subjecting the foodstuff to a high pressure processing (HPP) treatment sufficient to inactivate at least some VFCOs in the foodstuff and
aseptically sealing a package containing the foodstuff in fluid communication with a first microbistat in an amount sufficient to substantially inactivate substantially all VFCOs within the package that are not inactivated by the HPP treatment
to yield a packaged foodstuff that remains comestible after storage at 4 degrees Celsius for one month.

32. A packaged botanical foodstuff that remains comestible after storage at 4 degrees Celsius for six months, the packaged foodstuff made by a process comprising
subjecting the foodstuff to a high pressure processing (HPP) treatment sufficient to inactivate at least some viable food-contaminating organisms (VFCOs) in the foodstuff and
aseptically sealing a package containing the foodstuff in fluid communication with a first microbistat in an amount sufficient to substantially inactivate substantially all VFCOs within the package that are not inactivated by the HPP treatment,
wherein the process does not include heating the foodstuff to a temperature sufficient to inactivate substantially all VFCOs in the foodstuff.
